(19) United States
(12) Patent Application Publication
(10) Pub. No.: US 2021/0264195 A1
(43) Pub. Date: Aug. 26, 2021

(54) TECHNOLOGIES FOR ENABLING ANALYTICS OF COMPUTING EVENTS BASED ON AUGMENTED CANONICALIZATION OF CLASSIFIED IMAGES

(71) Applicant: SPLASHLIGHT HOLDING LLC, New York, NY (US)

(72) Inventors: James A. INGRAM, New York, NY (US); Benoit LAGARDE, New York, NY (US); Peter GUNTHER, New York, NY (US); Jason KEEBER, New York, NY (US); Thomas WALSHAM, Hamilton (CA); James VARGA, Toronto (CA); Josh ZUCKER, Toronto (CA)

(73) Assignee: SPLASHLIGHT HOLDING LLC, New York, NY (US)

(21) Appl. No.: 17/187,139

(22) Filed: Feb. 26, 2021

Related U.S. Application Data
(63) Continuation of application No. PCT/US2019/049074, filed on Aug. 30, 2019.
(60) Provisional application No. 62/724,905, filed on Aug. 30, 2018.

(51) Int. Cl. G06K 9/62; G06F 16/51; G06F 16/583; G06F 16/58; G06F 16/535; G06K 9/00; G06F 16/55

(52) U.S. Cl. CPC G06K 9/628; G06F 16/51; G06F 16/583; G06F 16/5866; G06K 2009/00328; G06K 9/00288; G06F 16/55; G06K 9/00248; G06F 16/535

(57) ABSTRACT

This disclosure discloses various computing technologies that enable a user to operate a browser to browse a web page that hosts a set of images and an operator of the web page to granularly track how the user is operating the browser with respect to the set of images based on various contextual information depicted in the set of images. Note that this disclosure is not limited to browsers and can be applied to other types of software applications, such as domain dedicated applications, such as e-commerce applications, photo gallery applications, encyclopedia applications, inventory applications, videogame applications, educational applications, social media applications, video streaming applications, or others, or others.

### CROSS-REFERENCE TO RELATED APPLICATIONS

This application is a continuation of PCT International Application No. PCT/US2019/049074, filed Aug. 30, 2019, which claims priority to U.S. Provisional Patent Application Ser. No. 62/724,905, filed Aug. 30, 2018, entitled “TECHNOLOGIES FOR ENABLING ANALYTICS OF COMPUTING EVENTS BASED ON AUGMENTED CANONICALIZATION OF CLASSIFIED IMAGES.” The disclosures of the above applications are incorporated herein by reference in their entirety.

### TECHNICAL FIELD

Generally, this disclosure relates to network-based computing. More particularly, this disclosure relates to augmented canonicalization of classified images.

### BACKGROUND

A user may operate a browser to browse a web page that includes a set of images. However, there is no technology that enables an operator of the web page to granularly track how the user is operating the browser with respect to the set of images based on various contextual information depicted in the set of images. Accordingly, this disclosure enables such technology.

### SUMMARY

In various implementations of the present disclosure, there is provided a method comprising: generating, via the server, a plurality of copies of an image; applying, via the server, a plurality of preprocessing techniques to the copies such that the copies are modified based on the preprocessing techniques; causing, via the server, the copies as modified to be stored in a plurality of virtualized storage units based on the preprocessing techniques, wherein the processing techniques one-to-one correspond to the virtualized storage units; retrieving, via the server, a plurality of configuration files one-to-one corresponding to a plurality of classification engines; causing, via the server, the copies to be sent from the virtualized storage units to the classification engines based on the configuration files such that the classification engines can classify the copies and thereby generate a plurality of classification result sets for each of the copies, wherein the classification engines are distinct from each other in operation such that the classification result sets are distinct from each other in content for each of the copies; receiving, via the server, the classification result sets from the classification engines; accessing, via the server, a plurality of taxonomy documents one-to-one corresponding to the classification engines; canonicalizing, via the server, the classification result sets based on the taxonomy documents such that a plurality of canonicalized data sets is formed; merging, via the server, the canonicalized data sets into a data structure; augmenting, via the server, the data structure with a set of metadata derived from the classification result sets; and taking, via the server, an action based on the data structure as augmented.

In further implementations of the present disclosure, there is described a method comprising: receiving, via a server, a cursor event generated via a script of a web page open in a browser such that the cursor event is associated with an image shown on the web page, wherein the cursor event includes a web page identifier and a network address; validating, via the server, the web page identifier; geolocating, via the server, the browser via the network address based on the web page identifier being valid; pushing, via the server, the cursor event to a stream based on the web page identifier such that the stream streams the cursor event to a virtualized storage unit and causes the cursor event to be copied from the virtualized storage unit to a data warehouse; accessing, via the server, a data structure storing a plurality of canonicalized data sets formed from classifications of the image merged together and augmented with a set of metadata derived from the classification result sets; identifying, via the server, a pattern based on the cursor event and the data structure; taking, via the server, an action based on the data structure.

In other implementations, a computer-implemented method for generating an augmented data structure for an image is disclosed. The method can include generating, via a computing device having one or more processors, a plurality of copies of the image. A plurality of preprocessing techniques can be applied to the copies to generate modified copies. The modified copies can correspond to modified versions of the copies based on the preprocessing techniques. The method can further include causing, via the computing device, each modified copy to be stored in a particular virtualized storage unit of a plurality of virtualized storage units. The selection of the particular virtualized storage unit for each modified image can be based on the preprocessing techniques utilized to obtain that modified image. The method can also include retrieving, via the computing device, a plurality of classifier settings for a plurality of classification engines. Each classifier setting of the plurality of classifier settings can correspond to a particular classification engine and specify a type of image to be classified by the particular classification engine. The computing device can cause the modified copies to be sent from the plurality of virtualized storage units to the classification engines based on the classifier settings. The method can additionally include receiving, via the computing device, a plurality of classification result sets for the modified copies from the classification engines, where the plurality of classification result sets have been generated by the plurality of classification engines. Also, the method can include accessing, via the computing device, a plurality of taxonomy label sets, where each particular taxonomy label set can correspond to a particular classification engine and can include categories or attributes to a specific knowledge or technical domain of the image. The method can further include canonicalizing, via the computing device, the classification result sets based on the taxonomy label sets to generate a plurality of canonicalized data sets and merging, via the computing device, the plurality of canonicalized data sets into a single data structure. According to the method, the computing device can also augment the data structure with a set of metadata derived from the classification result sets to obtain the augmented data structure for the image.

In further implementations of the present disclosure, there is described a method for generating a recommendation for image characteristics. The method can include receiving, via a computing device having one or more processors, a computing event generated via a script of a web page open in a browser. The computing event can be associated with an image shown on the web page and relating to engagement with the image by a user of the browser and can include a web page identifier and a network address. The web page identifier can be validated, via the computing device, to confirm the web page is open in the browser and the computing device can geolocate the browser via the network address based on the web page identifier being valid. The method can further include pushing, via the computing device, the computing event to a stream based on the web page identifier for storage at a virtualized storage unit and copying from the virtualized storage unit to a data warehouse. The method can also include accessing, via the computing device, a data structure storing a plurality of canonicalized data sets formed from classifications of the image merged together and augmented with a set of metadata derived from a plurality of classification result sets. The computing device can identify a pattern based on the computing event and the data structure, where the pattern is associated with one or more image characteristics corresponding to engagement with images by users. The method can additionally include generating, via the computing device, the recommendation for image characteristics based on the pattern.

### DESCRIPTION OF DRAWINGS

FIG. 1 shows a diagram of an embodiment of a system for providing analytics of application behavior based on augmented canonicalization of classified images according to this disclosure.

FIG. 2 shows a flowchart an embodiment of an overall process for providing analytics of application behavior based on augmented canonicalization of classified images according to this disclosure.

FIG. 3 shows a diagram of an embodiment of a system for preprocessing an image according to this disclosure.

FIG. 4 shows a diagram of an embodiment of a pre-built deep learning vision model according to this disclosure.

FIG. 5 shows a diagram of an embodiment of a system for classification of an image according to this disclosure.

FIG. 6 shows a diagram of an embodiment of a taxonomy according to this disclosure.

FIG. 7 shows a diagram of an embodiment of a face with a set of markers according to this disclosure.

FIG. 8 shows a diagram of an embodiment of a face with a set of distances from nose to lips and from lips to chin according to this disclosure.

FIG. 9 shows a diagram of an embodiment of a system for canonicalization and augmentation according to this disclosure.

FIG. 10 shows a diagram of an embodiment of a system for selecting a classifier according to this disclosure.

FIG. 11 shows a diagram of an embodiment of a database schema for image metadata according to this disclosure.

FIG. 12 shows a diagram of an embodiment of a system for capturing a computing event according to this disclosure.

FIG. 13 shows a diagram of an embodiment of a schema of a data mart according to this disclosure.

FIG. 14 shows a diagram of an embodiment of a system for performing an extract, transform, and load (ETL) job according to this disclosure.

FIG. 15 shows a diagram of an embodiment of a system for authentication an application programming interface (API) request for accessing a dashboard according to this disclosure.

FIG. 16 shows a screenshot of an embodiment of a dashboard of a web application according to this disclosure.

FIG. 17 shows a flowchart of an embodiment of a process for augmenting a set of canonical data obtained based on a plurality of results from a plurality of network-based classification engines according to this disclosure.

FIG. 18 shows a flowchart of an embodiment of a process for swapping a plurality of network-based classification engines according to this disclosure.

### DETAILED DESCRIPTION OF PREFERRED EMBODIMENTS

Generally, this disclosure enables various computing technologies that enable a user to operate a browser to browse a web page that includes a set of images and an operator of the web page to granularly track how the user is operating the browser with respect to the set of images based on various contextual information depicted in the set of images. This disclosure also describes the ingestion of images, the classification of the ingested images, and the creation of data structures representative of features, elements, and other aspects of the ingested images to form a “visual computational ethnography” system. Such a visual computational ethnography system can have the capability to (or be utilized or leveraged to) perform various tasks related to the capture, classification, and categorization of images, video, GIFs, and other visual media (generally referred to herein as “images” for the sake of simplicity). Among other capabilities, such technologies can enable the operator of the web page to map image engagement to image metadata and determine various trends and patterns to build a recommendation engine that can inform a creative process for creation of imagery. For example only, the operator of the web page can determine that a first set visitors of the web page from a first network address range or geographical area may or may not interact with at least one image of the set of images in a similar or dissimilar way as a second set of visitors of the web page from a second network address range or geographical area. The recommendation engine can inform the creative process to image objects, such as garments or others, or beings, such as people or others, based on trends and patterns captured, observed, or analyzed. For example only, granular tracking can be based on images shown, cursor events, zoom events, click events, other images shown at that time, or others. Note that this disclosure is not limited to browsers and can be applied to other types of software applications, such as domain dedicated applications, such as e-commerce applications, photo gallery applications, encyclopedia applications, inventory applications, videogame applications, educational applications, social media applications, video streaming applications, or others.

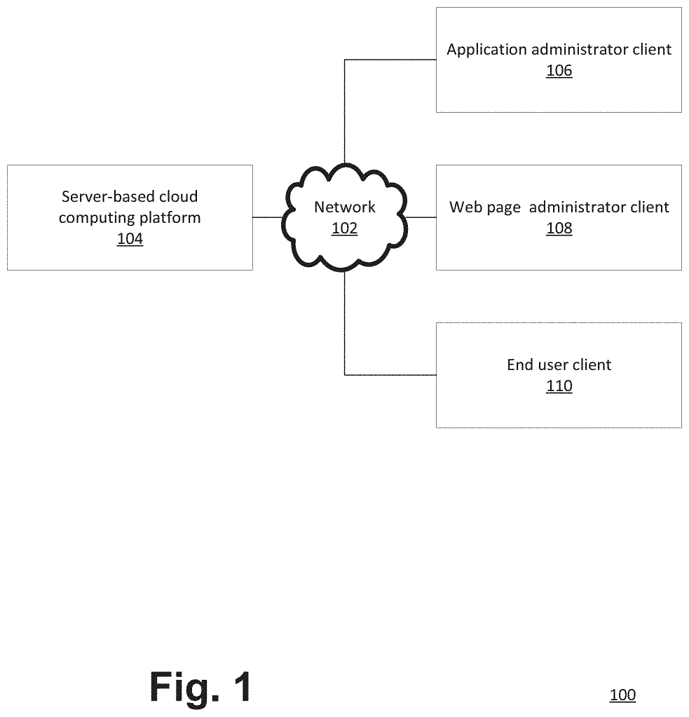

This disclosure is now described more fully with reference to FIGS. 1-18, in which some embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, or sections, these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

Hereby, all issued patents, published patent applications, and non-patent publications (including hyperlinked articles, web pages, and websites) that are mentioned in this disclosure are herein incorporated by reference in their entirety for all purposes, to same extent as if each individual issued patent, published patent application, or non-patent publication were specifically and individually indicated to be incorporated by reference. If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

FIG. 1 shows a diagram of an embodiment of a system for providing analytics of application behavior based on augmented canonicalization of classified images according to this disclosure. In particular, a system 100 includes a network 102, a computing platform 104 and a plurality of clients 106, 108, and 110. The computing platform 104 and the clients 106, 108, and 110 are in communication with the network 102.

The network 102 includes a plurality of computing nodes interconnected via a plurality of communication channels, which allow for sharing of resources, applications, services, files, streams, records, information, or others. The network 102 can operate via a network protocol, such as an Ethernet protocol, a Transmission Control Protocol (TCP)/Internet Protocol (IP), or others. The network 102 can have any scale, such as a personal area network (PAN), a local area network (LAN), a home area network, a storage area network (SAN), a campus area network, a backbone network, a metropolitan area network, a wide area network (WAN), an enterprise private network, a virtual private network (VPN), a virtual network, a satellite network, a computer cloudnetwork, an internetwork, a cellular network, or others. The network 102 can include an intranet, an extranet, or others. The network 102 can include Internet. The network 102 can include other networks or allow for communication with other networks, whether sub-networks or distinct networks.

The computing platform 104 includes a cloud computing environment defined via a plurality of servers, whether hardware or virtual, where the servers operate in concert, such as via a cluster of servers, a grid of servers, a group of servers, or others, to perform a computing task, such as reading data, writing data, deleting data, collecting data, sorting data, or others. In some embodiments, the computing platform 104 can include a mainframe, a supercomputer, or others. The servers can be housed in a data center, a server farm or others. The computing platform 104 can provide a plurality of computing services on-demand, such as an infrastructure as a service (IaaS), a platform as a service (PaaS), a packaged software as a service (SaaS), or others. For example, the computing platform 104 can providing computing services from a plurality of data centers spread across a plurality of availability zones (AZs) in various global regions, where an AZ is a location that contains a plurality of data centers, while a region is a collection of AZs in a geographic proximity connected by a low-latency network link. For example, the computing platform 104 can enable a user to launch a plurality of virtual machines (VMs) and replicate data in different AZs to achieve a highly reliable infrastructure that is resistant to failures of individual servers or an entire data center. For example, the computing platform 104 can include Amazon Web Services (AWS), Microsoft Azure, Google Cloud, IBM cloud, or others.

Each of the clients 106, 108, and 110 includes a logic that is in communication with the computing platform 104 over the network 102, whether in a wired, wireless, or waveguide manner. When the logic is hardware-based, then at least one of the clients 106, 108, and 110 can include a desktop, a terminal, a kiosk, a tablet, a smartphone, a wearable, a vehicle (land/marine/aerial), a physical server, a mainframe, a videogame console, or others. For example, when the logic is hardware-based, then at least one of the clients 106, 108, and 110 can include an input device, such as a mouse, a keyboard, a camera, whether forward-facing and/or back-facing, an accelerometer, a touchscreen, a biometric reader, a clicker, a joystick, a videogame controller, a microphone, or others. Likewise, when the logic is hardware-based, then at least one of the clients 106, 108, and 110 can include an output device, such as a display, a speaker, a headphone, a joystick, a videogame controller, a printer, or others. In some embodiments, the input device and the output device can be embodied in one unit. When the logic is software-based, then at least one of the clients 106, 108, and 110 can include a software application, a browser, a software module, an executable or data file, a database management system (DBMS), a browser extension, a mobile app, or others. Whether the logic is hardware-based or software-based, the clients 106, 108, and 110 can be embodied identically or differently from each other in any permutational manner and, as such, the logic can be correspondingly be implemented identically or differently in any permutational manner. Regardless of how the logic is implemented, the logic enables each of the clients 106, 108, and 110 to communicate with the computing platform 104, such as to request or to receive a resource/service from the computing platform 104 via a common framework, such as a hypertext transfer protocol (HTTP), a HTTP secure (HTTPS) protocol, a file transfer protocol (FTP), or others. In some embodiments, the logic enables the clients 106, 108, and 110 to communicate with each other.

The client 106 is operated by an application administrator, who has a set of application administration rights over an application instance running on the computing platform 104. The client 108 is operated by a web page administrator, who has a set of web page administration rights over a web page running on or accessible to the computing platform 104. The client 110 is operated by an end user, who may be browsing the web page. Note that at least some of these functionalities may overlap, such as when at least two of the application administrator, the web page administrator, or the end user client is a same user.

In one mode of operation, as further explained below, the system 100 is configured to enable a user to operate a browser to browse a web page that depicts a set of images and an operator of the web page to granularly track how the user is operating the browser with respect to the set of images based on various contextual information depicted in the set of images.

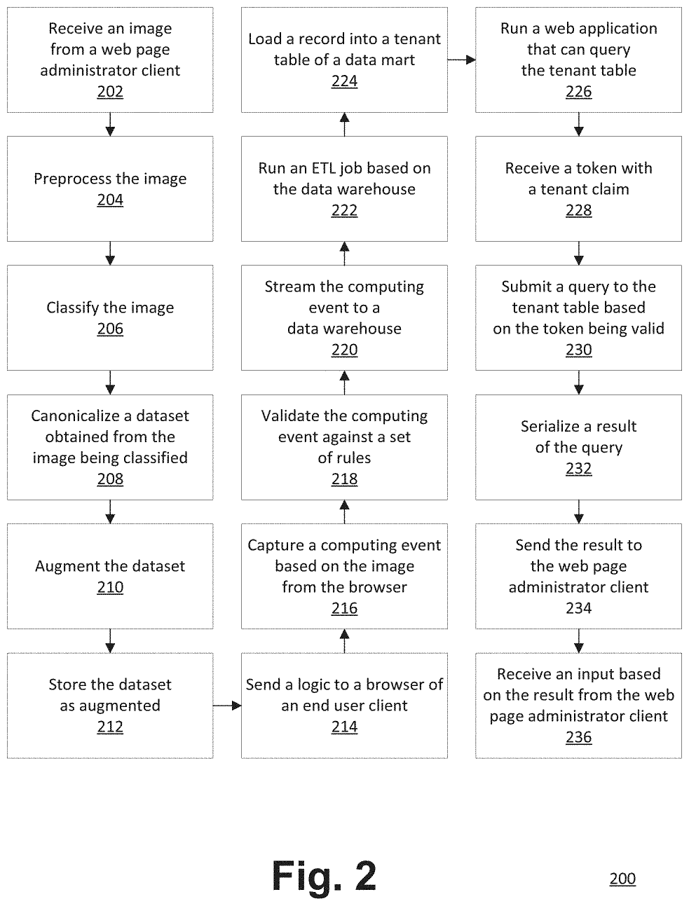

FIG. 2 shows a flowchart an embodiment of an overall process for providing analytics of application behavior based on augmented canonicalization of classified images according to this disclosure. In particular, a process 200 includes a plurality of blocks 202-236 which describe an overall technique for providing analytics of application behavior based on augmented canonicalization of classified images. The process 200 can be performed via the system 100.

In block 202, the computing platform 104 receives an image from a browser running on an operating system (OS) of the client 108 over the network 102. The image can include a digital image in a raster or vector format, but can be in an analog format as well (conversion may be needed). For example, the image can depict a face or a limb or a torso of a person or a person as a whole, a product or item or service being marketed, or others. The image can include a still photo, a caricature, a computer aided design (CAD) image, a diagram, a flowchart, a hand-drawn or computer drawn imagery, an image captured via a non-optical image capture device, such as a sonar device, an X-Ray device, a radar device, a lidar device, or others, or others. The image can binarized, grayscale, monochrome, colored (red, green, blue), or others. For example, the browser can include Firefox, Chrome, Safari, Internet Explorer, Edge, Silk, or others. For example, the OS can include Windows, MacOS, Android, iOS, Unix, Linux, or others.

In block 204, the computing platform 104 preprocesses the image and the copies are preprocessed. The preprocessing can include cropping, binarizing, adjusting tones, adjusting contrast, adjusting brightness, filtering, dewarping, or others. In some aspects, a plurality of copies of the image are generated and the preprocessing techniques are applied to the copies in order to generated modified copies of the image. The modified copies of the image correspond to modified versions of the copies of the image in that the modified copies have been preprocessed as described herein. In this manner, the original image and the modified copies of the image (as modified by the preprocessing techniques) can be linked, and the modified copies of the image can be classified as described more fully below.

In block 206, the computing platform 104 classifies the image, which can include submitting the image for classification into a classification engine, whether local to or remote from the computing platform 104. The image can be classified based on various features depicted in the images, such as facial features, garment features, or others, and raw results of such classification are stored.

In block 208, the computing platform 104 canonicalizes a dataset obtained from the image being classified. Such canonicalization can be based on a taxonomy available to the computing platform 104. For example, the taxonomy can be stored in a data structure, such as a file, an array, a database, or others, and contain a variety of categories and attributes to a specific knowledge or technical domain, such as fashion photography, food photography, garment photography, equipment photography, product photography, or others. Resultantly, the computing platform 104 canonicalizes the dataset based on mapping a result from the classification engine to a normalized format.

In block 210, the computing platform 104 augments the dataset, as canonicalized. The dataset is augmented based on insertion of additional metadata derived from various outputs from the classifier engine. For example, when dealing with fashion photography, then the dataset can be augmented based on fashion model profile augmentation, facial attribute ratio determination, negative space determination, or others.

In block 212, the computing platform 104 stores the dataset as augmented.

In block 214, the computing platform 104 sends a logic over the network 102 to a browser running on an OS of the client 110. The logic can include a script, a beacon, a tracker, or others. For example, the code can include a JavaScript code. The computing platform 104 can send the logic before or as the end user client 110 is browsing a web page that depicts the image as received via the computing platform in block 202. For example, the browser can include Firefox, Chrome, Safari, Internet Explorer, Edge, Silk, or others. For example, the OS can include Windows, MacOS, Android, iOS, Unix, Linux, or others.

In block 216, the computing platform 104 captures a computing event, such as a cursor event, a keyboard event, or others, based on the image from the browser of the end user client 110 over the network 102. For example, the cursor event can be based on a cursor being operated via an end user of the end user client 110. The cursor can be operated via an input device, such as a motion-tracking pointing device, a position-tracking pointing device, a pressure-tracking pointing device, or others. The motion-tracking pointing device can include a mouse, a trackball, a joystick, a pointing stick, a Wii Mote or Wii Remote, a finger tracking device (tracks fingers in a 3D space or close to a surface without contact with a screen—fingers are triangulated by technologies like stereo camera, time-of-flight, laser), or others. The position-tracking pointing device can include a graphics tablet, a stylus, a touchpad, a touchscreen, or others. The pressure-tracking device can include an isometric joystick, or others. Note that the computing event can include a non-cursor or non-keyboard event, such as an eye tracking event, a dial or knob event, an accelerometer event, an inertial measurement unit (IMU) event, a gyroscope event, or others. The computing event can be sent as that event occurs, in a group of computing events, a stream of events, or others.

In block 218, the computing platform 104 validates the computing event against a set of rules, whether stored on the computing platform 104 or available to the computing platform 104. The set of rules can be stored in a data structure, such as a table, an array, or others. For example, the computing platform 104 can validates to see whether a field is or is not present, a field has or has not been populated with a variable, a valid alphanumeric value is or is not stored, or others. For example, the computing platform 104 drop a request and log an error message based on such validating failing to satisfy a predetermined threshold.

In block 220, the computing platform 104 streams the computing event to a data warehouse, whether the data warehouse is stored on the computing platform 104 or available to the computing platform 104.

In block 222, the computing platform 104 runs an ETL job based on the data warehouse. For example, the ETL job can include the computing event stored on the data warehouse.

In block 224, the computing platform 104 loads a record into a tenant table of a data mart based on the ETL job. The data mart is based on the data warehouse. The tenant table is associated with operator of the web page, as noted above.

In block 226, the computing platform 104 runs a web application that can query the tenant table. The web application can be administered over the network 102 via a browser running on an OS of the client 106 as the client 106 is being operated via the application administrator. The web application can include an administrator graphical user interface (GUI), which enables administration of the web application. The web application can include a web page operator GUI, which enables analytics of the image based on the computing event. For example, the browser can include Firefox, Chrome, Safari, Internet Explorer, Edge, Silk, or others. For example, the OS can include Windows, MacOS, Android, iOS, Unix, Linux, or others.

In block 228, the computing platform 104 receives a token with a tenant claim from the client 108 over the network 102. The token can be based on a login of the client 108 into the computing platform 104 over the network 102 in order to access the web page operator GUI over the network 102. Upon validation, the tenant claim enables the web page operator GUI to provide the client 108 over the network 102 with analytics for the image based on the computing event stored in the tenant table.

In block 230, the computing platform 104 enables the web page operator GUI to submit a query over the network 102 to the tenant table based on the token being validated.

In block 232, the computing platform 104 serializes a result of the query for service to the client 108. For example, the computing platform 104 can serialize based on translating a data structure or an object state into a format that can be stored, such as in a file, a memory buffer, a data structure, a database, or others, or transmitted, such as across a network connection link, and reconstructed later, which can be in a different computer environment).

In block 234, the computing platform 104 sends the result, as serialized, to the client 108 over the network 102 for presentation within the browser running on the OS of the client 108.

In block 236, the computing platform 104 receives an input from the web page operator GUI from the client 108 over the network 102. The input can be responsive to the result presented within the browser running on the OS of the client 108. For example, the input can include at least one of save data onto the client 108, send data from the computing platform 108 to another client, reformat data, print data, share data, encrypt data, archive data, compress data, or others.

As further described below, the process 200 enables image classification by combining distinct classifiers based on a set of image classifiers and classification services to identifying various attributes of an image based on a taxonomy list. The taxonomy list includes attributes specific to a knowledge or technical domain, such as fashion photography, food photography, garment photography, equipment photography, product photography, or others. As described below, the fashion photography is used, but note that such use is illustrative and other knowledge or technical domains are possible and can be used. The image classification includes preprocessing, image classification, canonicalization, and augmentation, all of which are further described below.

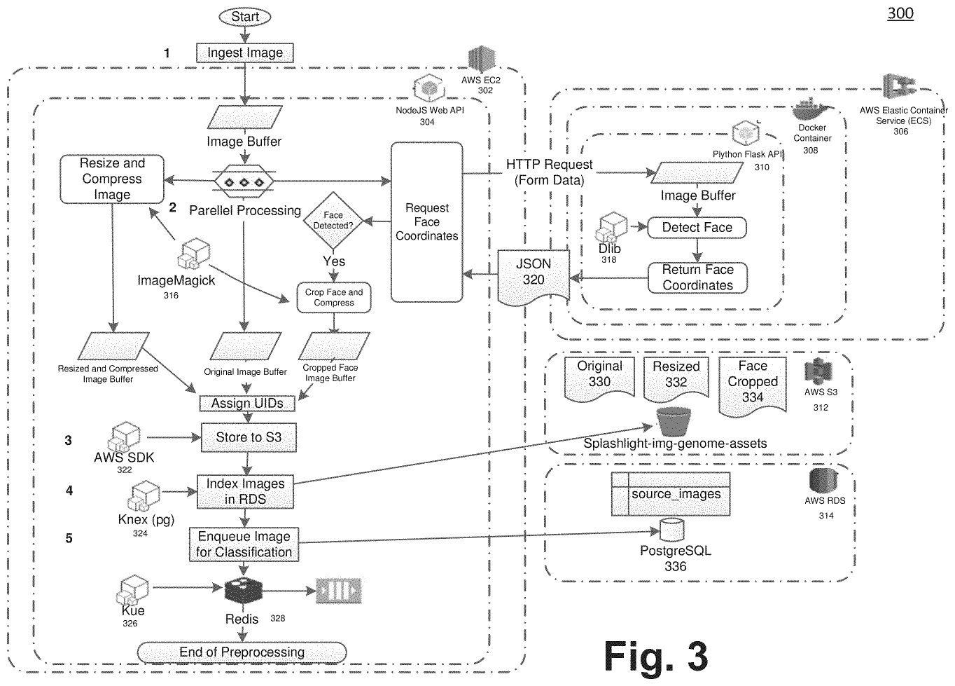

FIG. 3 shows a diagram of an embodiment of a system for preprocessing an image according to this disclosure. In particular, a system 300 is implemented via the computing platform 104 and the client 108. The system 300 performs blocks 202-204 of FIG. 2. Note that although the system 300 is described in context of AWS, the system 300 is not limited to AWS and can be implemented in other ways, whether alternatively or additionally. For example, the system 300 can be implemented via Microsoft Azure, Google Cloud, IBM cloud, or others.

The system 300 includes a virtual server set 302, which operates as an on-demand computational unit or instance. For example, the virtual server set 302 can be implemented as an Amazon Elastic Compute Cloud (EC2) or others for providing on-demand computational capacity. The virtual server set 302 is instantiated for a computing capacity and size, tailored to specific workload types and applications, such as memory-intensive and accelerated-computing jobs, as disclosed herein, while also auto scaling to dynamically scale capacity to maintain instance health and performance. When implemented as EC2, the virtual server set 302 can hosts an AWS EC2 Container Service and an EC2 Container Registry enable work with a Docker container and a set of binary images on the virtual server set 302.

The virtual server set 302 contains a web API 304, which can be a compliant with a representational state transfer (REST) style and can include a cross-platform runtime environment for developing server-side and networking applications. For example, the web API 304 can include a Node.JS web API or others. Note that non-JavaScript code methodology can be used well. For example, the web API 304 can be asynchronous (non-blocking) and event driven—server does not waits for an API to return data and the server moves on to the API after calling the API and a notification mechanism of events helps the server to get a response from a previous API call. Further, the virtual server set 302 can include a single threaded model with event looping (event mechanism helps a server to respond in a non-blocking way and makes the server highly scalable as opposed to traditional servers which create limited threads to handle requests—a single threaded program can provide service to a much larger number of requests than a traditional server). Moreover, the virtual server set 302 can be configured not to buffer data and output data in chunks.

The web API 304 is in communication with a web service 306 that hosts or accesses a Docker container 308 (a software logic that can perform an operating-system-level virtualization/containerization). The web service 306 is hosted on or accessible to the computing platform 104. The Docker container 308 hosts a software package (container) containing a logical standardized unit including libraries, system tools, code, and runtime relevant to that logical standardized unit to be run or instantiated. For example, the web service 304 can include an AWS Elastic Container Service (ECS) or others. The Docket container 308 hosts or accesses a micro web framework 310, such as a Flask micro framework written in Python or others. The micro web framework 310 supports extensions that can add application features as if those features were implemented in the micro web framework 310 itself. The micro web framework 310 hosts extensions for object-relational mappers, form validation, upload handling, various open authentication technologies and several common framework related tools.

The web API 304 is in communication with a storage service 312, which is configured for at least one of object storage, file storage, or block storage via a web service interface, such as a REST interface, a simple object access protocol (SOAP), a Bit Torrent protocol, or others. For example, the storage service 312 can include an AWS S3 service where a basic storage unit is an object that is organized into a bucket and identified within the bucket by a unique user assigned alphanumeric identifier or key. The storage service 312 is hosted on or accessible to the computing platform 104. The storage service 312 includes a first bucket 330, a second bucket 332, and a third bucket 334, each of which is configured for storage of images as further explained below.

The web API 304 is in communication with a database service 314 which can be deployed over a plurality of AZs and can enable read replicas. The database service enables that administration processes, such as patching database software, backing up databases, and enabling point-in-time (PIT) recovery, or others, can be managed automatically, such as via the client 106. For example, the database service can include a relational database, such as an AWS RDS service or others. The database service 314 hosts or accesses an object-relational database management system 336 (ORDBMS), which can be used as a database server, such as PostgreSQL or others. The ORDBMS 336 transacts with atomicity, consistency, isolation, and durability (ACID) compliancy and has updatable views and materialized views, triggers, foreign keys; supports functions and stored procedures, and other expandability. Note that the database service 314 can be non-relational, such as a post-relational database, an in-memory database, a hybrid database, an Extensible Markup Language (XML) database, a parallel database, a distributed database, a graph database, a mobile database, an operation database, a probabilistic database, a real-time database, a spatial database, a temporal database, an object-oriented database, an unstructured data database, a terminology oriented database, or others. The database service 314 is hosted on or accessible to the computing platform 104.

The web API 304 hosts or accesses an image processing logic 316 to create, edit, or compose bitmap images. The image processing logic 316 can read, convert and write images in a large variety of formats, such as GIF, JPEG, JPEG-2000, PNG, PDF, PhotoCD, TIFF, DPX, or others. The image processing logic 316 can enable images can be cropped, colors can be changed, various effects can be applied, images can be rotated and combined, and text, lines, polygons, ellipses and Bezier curves can be added to images and stretched and rotated, or others. For example, the image processing logic 316 can be configured to convert an image from one format to another (e.g. TIFF to JPEG), resize, rotate, sharpen, color reduce, or add special effects to an image, create a montage of image thumbnails, create a transparent image suitable for web use, turn a group of images into a GIF animation sequence, create a composite image by combining several separate images, draw shapes or text on an image, decorate an image with a border or frame, describe a format and characteristics of an image, or others. The image processing logic 316 can be network-based. For example, the image processing logic 316 can include ImageMagick or others.

The micro web framework 310 hosts or accesses a library of machine learning algorithms 318. For example, the library of machine learning algorithms includes software components for dealing with networking, threads, graphical user interfaces, data structures, linear algebra, machine learning, image processing, computer vision, data mining, XML and text parsing, numerical optimization, Bayesian networks, statistical tools, or others. The library of machine learning algorithms 318 can be network-based. For example, the library of machine learning algorithms 318 includes a Dlib toolkit.

The system 300 includes a data structure 320 in an open-standard file format that uses human-readable text to transmit data objects including attribute-value pairs and array data types (or any other serializable value). The data structure 320 can be used for asynchronous browser-server communication, including as a replacement for XML in some AJAX-style systems. For example, the data structure 320 can include a JavaScript Object Notation (JSON) object, Internet JSON (I-JSON), or others.

The web API 304 hosts or accesses a network-based software development kit (SDK) 322, which can be network-based. For example, the SDK 322 can include an AWS SDK or others.

The web API 304 hosts or accesses an editor 324 to help write a database query, such as a standard query language (SQL) query. The editor 324 can be network-based. For example, the editor 325 can include a SQL query builder for Postgres, MSSQL, MySQL, MariaDB, SQLite3, Oracle, Amazon Redshift, or others. The editor 324 can include a traditional node style callbacks as well as a promise interface for cleaner async flow control, a stream interface, a query and schema builders, a transaction support (with a save points), connection pooling and standardized responses between different query clients and dialects, or others. For example, the editor 324 can include a KNEX.JS query building tool or others.

The web API 304 hosts or accesses a priority job queue 326, which can be network-based. The priority job queue 326 can include a GUI for viewing and managing queued, active, failed, and completed jobs. The priority job queue 326 can be backed by an in-memory database key-value store 328, which can support different kinds of abstract data structures, such as strings, lists, maps, sets, sorted sets, hyperloglogs, bitmaps, spatial indexes, or others. The web API 304 can host or access the in-memory database key-value store 328 For example, the priority job queue 326 can include a Kue priority job queue (https://automattic.github.io/kue) for Node.JS backed by a Redis store.

Based on various components of the system 300 described above, the system 300 is configured to perform image preprocessing, such as per block 204. In particular, before images are classified, the images undergo some preprocessing to prime the images for classification process. Preprocessing resizes and compresses images to ensure that the images meet various size and format requirements of various image classification services. For example, the images can be cropped as needed to improve classifier performance. For example, when used in context of fashion photography, by cropping out everything but a fashion model's face, there can be an improved facial attribute classifier performance and facial recognition. As such, the computing platform 104, such as via the virtual server set 302, can receive the images, such as via image files, streaming, file sharing, or others, from client 108. Those files can be stored on the client 108 prior to copying and uploading to the computing platform 104 or otherwise being accessible to the client 108 or the browser of the client 108. Those files can also be sent to the computing platform 104 from a data source remote from the client 108, such as via a network-based file sharing service, whether peer-to-peer (P2P) or cloud-based, such as Napster, Bit Torrent, Dropbox, Box, Egnyte, Google Drive, Microsoft OneDrive, Microsoft SharePoint, Microsoft Teams, Slack, Apple iCloud, and others. For example, the image files can be stored local to the client 108 before copying and uploading to the computing platform 104 or remote from the client 108 before copying and uploading to the computing platform 104. For example, the files, as copied, can be received from the browser of the client 108 based on a user selection of the files prior to copying and uploading to the computing platform 104, with the user selection being made via the client 108. For example, the files, as copied, can be received from a data source, such as a network-based file sharing service, remote from the client 108 based on a user selection of the files, whether locally or remotely via the client 108. Note that at least one of the files can be a data file, such as an image file, a productivity document file, such as a Microsoft Word file, a Microsoft Excel file, a Portable Document Format (PDF) file, an archive file, or others, whether or not password protected or archived. Likewise, note that at least one of the files can be an executable file, such as a.BAT file, a.COM file, a.EXE file, a .BIN file, or others, whether executable in a Windows environment or other OS environments, inclusive of distributed environments. Note that the computing platform 104 can check the files for viruses or other malware when receiving the files. If the computing platform 104 detects at least one of the files to contain the virus or other malware, then the computing platform 104 can inform the client 108 of such and delete or sandbox that file.

Accordingly, when used in context of fashion photography, based on step 1 of the system 300, an image, such as in a JPG, TIF, PNG, BMP, or another format, can be uploaded via an HTTP to the web API 304, such as a NodeJS API hosted in an AWS EC2 cloud instance where the image is stored temporarily in physical memory (buffered) in the EC2 cloud instance. As described above, in some aspects copies of the image will be generated. Based on step 2 of the system 300, the image (e.g., the copies of the image) is pre-processed where at least two of (a) image modification, (b) cropping, or (c) image segmentation can be carried out in parallel to generate modified copies of the image. For example, the image modification can include the image being copied, and then the image is resized and compressed using a GraphicsMagick Image Processing System (http://www.graphicsmagick.org), where an original aspect ratio is kept, a longest edge is resized to 700 pixels (px), the image is compressed into a JPEG format with a quality value of 80% of the image. Note that these formats, values, and parameters are illustrative and can be modified as needed. Likewise, for example, if a face is detected in the image, then the image is copied and a copy of the image is cropped around the face. Such functionality can be performed via the image being sent to the micro web framework 310, such as a Python Flask web API hosted in a Docker container in an AWS ECS. The micro web framework 310 can employ the library of machine learning algorithms 318, such as a Dlib toolkit (http://dlib.net/) default frontal_face_detector to detect if a face is present, and then if a face is detected, then a set of bounding box coordinates of the face is extracted and returned as JavaScript Object Notation (JSON) to the NodeJS web API. As such, if the set of bounding box coordinates of the face are returned by the Flask API, then the NodeJS API crops the image using the GraphicsMagick Image Processing System, as explained above. Then, the image, as cropped, is stored in a buffer. Similarly, for example, the image segmentation can be carried out similar techniques as described above, but the image segmentation can include hair segmentation, human body segmentation, limb segmentation, garment segmentation, or others. Based on step 3 of the system 300, the images, as uploaded, resized, and cropped (e.g., the modified copies), are transferred from the buffer via an HTTP protocol stored to a virtualized storage unit (e.g., the storage service 312), such as an AWS S3 cloud storage bucket using the AWS SDK 322. A plurality of virtualized storage units can be utilized, where the particular virtualized storage unit in which an image or modified copy thereof can be selected based on the preprocessing technique(s) utilized to obtain the modified copy. For example only, the images/modified copies can be stored in the first bucket 330 (original images), the second bucket 332 (resized images), and the third bucket 334 (cropped images). Based on step 4 of the system 300, for each of the first bucket 330, the second bucket 332, and the third bucket 334, the images are named using a unique identifier technique, such as an RFC4122 (version 4) Universally Unique IDentifier (UUID), and the unique identifier, such as UUIDs, for each version of the image are then stored as part of a single image record in a PostgreSQL database hosted in an AWS RDS instance. Note that some, most, or all queries (SELECT, INSERT, UPDATE, DELETE or others) against the database service 314, such as a PostgreSQL database or others, are performed using the editor 324, such as a Knex.js query builder tool (https://knexjs.org). Based on step 5 of the system 300, the single image record is queried to place at least one image therefrom into the priority job queue 326 to be subsequently classified. The priority job queue 326 is needed to guarantee that each image submitted for classification and the priority job queue 326 relieves back pressure on a classification process and allows for granular control of job execution. Back pressure is a symptom of streaming data where the data is produced faster than the data can be flushed (the classification process may take longer than preprocessing).

As further explained below, after the image has been preprocessed, the image is ready for classification. However, note that the image can also be ready for classification without preprocessing. Regardless, the classification process uses a variety of network-based classifiers provided by third party web based classification services and custom developed classifiers, such as a software library for dataflow programming across a range of tasks, where this software library can be a symbolic math library or be configured for use for machine learning applications, such as neural networks or others. For example, the custom developed classifiers can include TensorFlow classifiers. The classifiers can be divided into various groups.

Some of such classifiers are general classifier services that are network-based, such as Google Image Classifier API, Microsoft Azure Computer Vision API, Amazon AWS SageMaker API, Clarifai API, or others. The general classifiers are multi-purpose classifiers that can output a wide variety of results, such as various objects recognized in an image, a gender of a person depicted in the image, an age of a person depicted in the image, an emotion of a person depicted in the image, or others. The general classifiers do not output fashion model specific attributes, but do contain some valuable attributes that can be used to help inform some attribute classification.

Some of such classifiers are customizable classifier services that are network-based. These classifiers similar to general classifiers, but allow for custom training on a specific attribute and allow an end user to upload training sets with tags to leverage machine learning in order to train those classifiers to detect an attribute of interest.

Some of such classifiers are custom classifiers that are network-based. For example, these classifiers can be developed based on a software library for dataflow programming across a range of tasks, where this software library can be a symbolic math library or be configured for use for machine learning applications, such as neural networks or others. For example, this software library can include TensorFlow SDK (https://www.tensorflow.org) and can be similar to custom trained classification services, training sets are used to train the classifier to detect specific attributes. For example, an image classifier, such as Inception v3 can be used as a base model, where this model uses imagenet dataset of nearly 1.2 million images with about 1,000 categories of manually tagged entities. The computing platform 104 uses a transfer learning approach to classify images by downloading a pre-trained model from a data source, such as a TensorFlow GitHub repo or others, and programmatically retrain specific layers of that convolutional network as needed. The convolution network has a last layer which is retrained, i.e., inference/classification layer to predict a set of custom attributes. For example, the last layer of the Inception v3 can be modified, as further explained below.

A custom train process can be employed to enhance accuracy. In particular, computer vision, neural networks and deep learning are complex subjects. At a high level, computer vision utilizes color and pattern recognition of pixels to detect objects based on neural network models trained by humans. These neural network models are trained using hundreds of thousands of images but are restricted to subject matter in which these models have been trained on. In order to detect attributes that are unknown to a classifier, a custom training set can be supplied to build or extend a model. Such the custom training set can be used to build or extend the model based on at least two distinct methods for custom classification, such as a Microsoft Custom Vision Service API and TensorFlow API. For example, the Microsoft Custom Vision Service API is a tool for building custom image classifiers and simplifies fast builds, deployment, and improvement of an image classifier. The Microsoft Custom Vision Service API provides a REST API, and a web interface tool for training. Currently, the Microsoft Custom Vision Service API works well when an item is prominent in an image since Microsoft Custom Vision Service API relies on image classification and not object detection. However, the Microsoft Custom Vision Service API does not work as well (although good enough) when trying to detect very subtle differences between images. Likewise, for example, using TensorFlow API or SDK can involve a use of Inception v3 as a base model where this model uses imagenet dataset of nearly 1.2 million images with about 1,000 categories of manually tagged entities. Using such technology, the computing platform 104 uses a transfer learning approach to classify images by downloading a pre-trained model from a data source, such as a TensorFlow GitHub repo or others and programmatically retrain specific layers of that convolution network as needed.

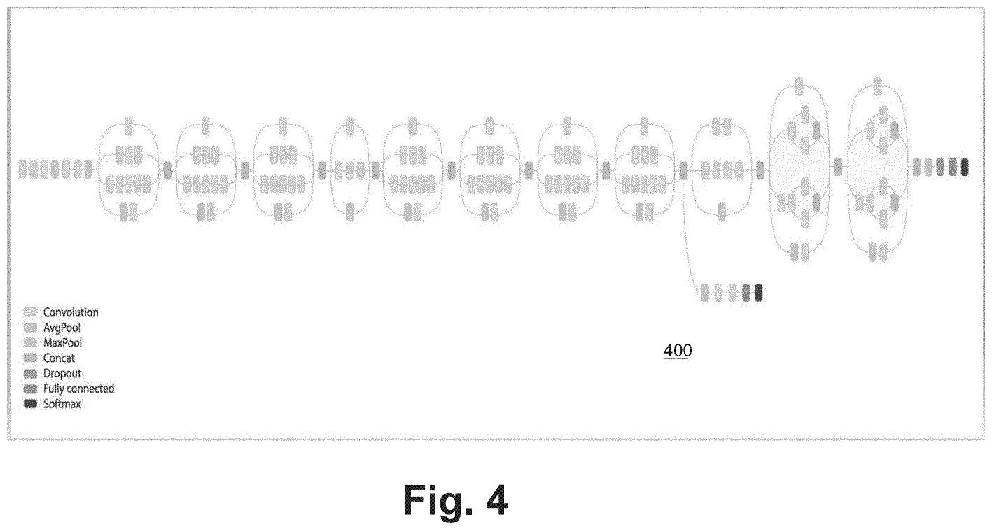

FIG. 4 shows a diagram of an embodiment of a pre-built deep learning vision model according to this disclosure. In particular, as shown in a pre-built deep learning vision model, each colored blob is a subnetwork with many parameters. Note that last few layers of this model indicate that some specific image classification is taking place. For example, one way to do transfer learning is to replace last two layers with two new ones and then retrain some trained parameters of previous layers starting from 0 to Length-2 constant (or nearly so). For example, a last layer of a convolution network can be retrained, i.e., inference/classification layer to predict various custom attributes, such as modifying a last layer of an Inception v3 model. Therefore, since a trained model is as good as a dataset for creating the trained model, in order to create that dataset, an accurate set of data for training is selected based on various guidelines. For example, some of such guidelines involve scope of learning, collection, training, validation, or others. For example, the scope of learning involves identifying and defining a scope for a model, i.e., what kind of images will the model predict, how will computer see those images, will the model predict multiple concepts for an image or perform binary classification, or others. For example, the collection involves obtaining more variables and diverse training datasets, i.e., different lighting conditions, variable object sizes, rotated images, good quality images with focus, images with objects at different distances and colors, or others. For example, using the TensorFlow SDK a minimum of 500 images for each attribute tag can be obtained. For example, for the training and validation, a dataset can be organized into a training and validation set, where a sufficient ratio for the TensorFlow SDK would be 60% images for training and 40% images for validation. Note that the validation dataset should have diverse set of images, since the validation dataset is used to predict an initial accuracy of a model.

A model can be trained via a training process. As described below, the training process employs the TensorFlow SDK and Inception V3 model, as described in https://www.tensorflow.org/tutorials/image_recognition or /image_retraining pages, but other SDKs and algorithms and configurations can be used, whether additionally or alternatively. For example, a training set of images with classification categories can be created to teach a convolution network, such as pose/standing, pose/leaping, pose/walking, or others. Various parameters described below can be tuned to increase speed or accuracy for the training process of the convolution model.

One of such parameters is bottleneck values, where a first phase of the training process analyzes a plurality of images on a disk, such as a group or cluster of images, and determines various bottleneck values for each of the images. Note that the bottleneck can refer to a layer just before a final output layer that actually performs classification. This penultimate layer has been trained to output a set of values that is good enough for a classifier to use in order to distinguish between some, most, or all classes the classifier has been asked to recognize. Because some, most, or all images may be reused multiple times during training and because determining each bottleneck is time consuming, in order to increase computational efficiency or speed, the computing platform 104 may cache these bottleneck values on the disk so that these bottleneck values don't have to be repeatedly re-determined.

One of such parameters is training sets. Once bottleneck process, as described above, is completed, then an actual training step of a top layer of a convolution network begins. For example, by default, this script can run 4,000 training steps, although less steps, such as 2,000 or less or others (inclusive of intermediate values), or more steps, such as 9,000 steps or more or others (inclusive of intermediate values). Each step chooses a set of images, such as ten images, at random from the training set, finds a bottleneck value for each member of the set from the cache, and feeds each member of the set into a final layer to get predictions. Those predictions are then compared against a set of actual labels to update various weights of the final layer weights through a back-propagation process. Note that increasing a training step count can increase a training speed and can improve accuracy or precision. Further, note that if the convolution network is over-trained with specific type of data, then the convolution network may start memorizing those images and irrelevant information about those images which will result in overfitting of data, i.e., some results might be true for some images seen during a training process but will fail or be less accurate or precise on newer images.

One of such parameters is distortions. Some images can be processed during training by using various pre-built libraries, such as in the TensorFlow SDK or others. For example, these distortions can be enabled by passing % values—random_crop, —random_scale, and —random_brightness in a script. This can help to increase a size of a dataset and add variation to some images.

One of such parameters is retraining. Once training is complete a predefined function or subroutine can be invoked to examine misclassified images in a test. For example, this function or subroutine can include —print_misclassified_images in the TensorFlow SDK or others. This function or subroutine call may help to understand various types of images that may have been most confusing for that model, and which categories were most difficult to distinguish. As such, that model can be retrained using similar images to improve precision or accuracy.

One of such parameters is deployment. The computing platform 104 wraps a training model into a REST API which can be integrated into an image classification pipeline. However, the computing platform 104 can also use tensorflow-serving infrastructure or others to create a production system using a remote procedure call (RPC) protocol.

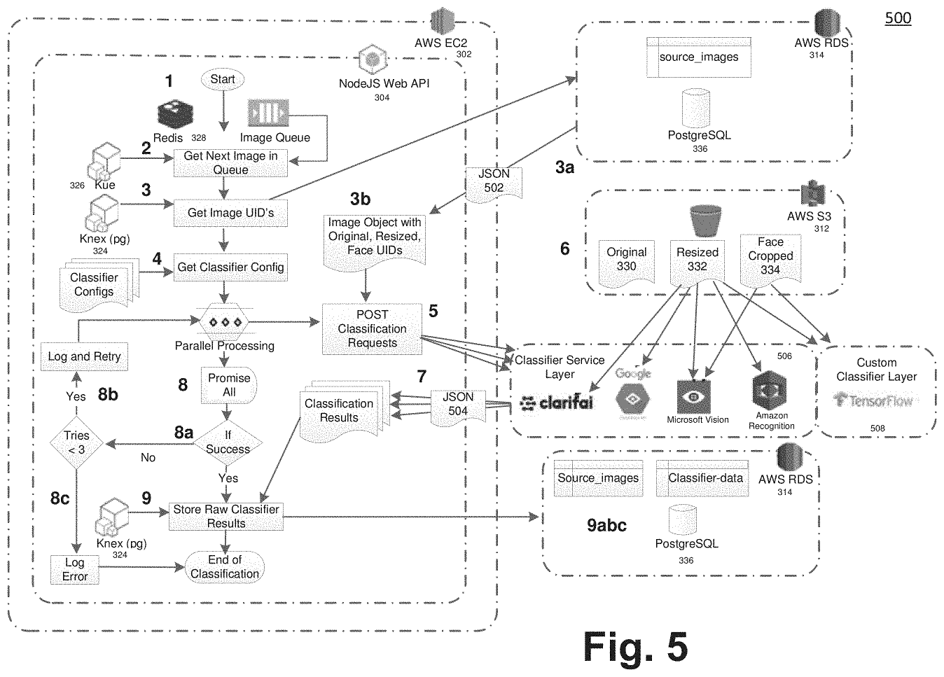

FIG. 5 shows a diagram of an embodiment of a system for classification of an image according to this disclosure. In particular, a system 500 shares some components with the system 300 (similar numbering). The system 300 performs block 206 of FIG. 2 and continues from block 204. Note that although the system 500 is described in context of AWS, the system 500 is not limited to AWS and can be implemented in other ways, whether alternatively or additionally. For example, the system 500 can be implemented via Microsoft Azure, Google Cloud, IBM cloud, or others.

When used in context of fashion photography, based on steps 1 and 2 of the system 500, after image preprocessing, some images are loaded from the in-memory database key-value store 328 into a queue to be classified. The web API 304 gets those images from the queue which is stored in the in-memory database key-value store 328, which is managed by the priority job queue 326, such as a Kue job queue service or others. Based on step 3 of the system 500, the queue contains a primary key of an image record that was previously stored in the PostgreSQL database 336. This primary key is used to query the PostgreSQL database 336 and retrieve an image UUID for each of the images that have been preprocessed and stored. Note that this query returns a data structure 502 in an open-standard file format that uses human-readable text to transmit data objects including attribute-value pairs and array data types (or any other serializable value). The data structure 502 can be used for asynchronous browser-server communication, including as a replacement for XML in some AJAX-style systems. For example, the data structure 502 can include a JavaScript Object Notation (JSON) object, Internet JSON (I-JSON), or others. As such, the query returns the data structure 502 that contains a UUID for that image or each image. The data structure is stored in memory of the web API 304 in preparation for subsequent classification.

Based on step 4 of the system 500, the computing platform 104 hosts or accesses a plurality of classifier settings or configurations. Each classifier setting or configuration can correspond to a particular classification engine and specify a type of image to be classified by the particular classification engine. Accordingly, a classifier setting or configuration can be retrieved for each supported classifier. The setting or configuration can be in a form of a data structure in an open-standard file format that uses human-readable text to transmit data objects including of attribute-value pairs and array data types (or any other serializable value). The data structure can be used for asynchronous browser-server communication, including as a replacement for XML in some AJAX-style systems. For example, the data structure can include a JavaScript Object Notation (JSON) object, Internet JSON (I-JSON), or others. For example, the setting or configuration can be in a form of a JSON file that can be referenced in the web API 304. As mentioned above, the setting or configuration can include a type of image to be submitted to the classifier, e.g., compressed version, face segment, body segment, or others. The setting or configuration can include a classifier uniform resource locator (URL) or others. The setting or configuration can further include identification ID, access keys or others. Additionally or alternatively, the setting or configuration can include special parameters such as a classifier model ID, version, or others.

Based on steps 5 and 6 of the system 500, once the setting or configuration of the classifier configuration is retrieved, the computing platform 104 can cause the modified copies of the image to be sent (e.g., from the virtualized storage units) to the classification engines, e.g., classification services 506, 508. Each modified copy can be sent to a particular classification engines based on the classifier settings. For example only, the computing platform 104 uses the setting or configuration of the classifier to POST an HTTP request to a classification service 506, 508. For example, the computing platform 104 can retrieve a plurality of settings or configurations of a plurality of classification services 506, 508 and then use those settings or configurations to post a perform a plurality of POST actions based on a plurality of HTTP requests to the classification services 506, 508 in parallel. Note that the POST requests use appropriate image UUIDs based on the settings or configurations. The POST requests contain a plurality of URLs of the storage service 312 for those buckets which allow images contained therein to be retrieved, which can be directed, from those buckets, by each of the classifier services 506, 508. This configuration avoids or minimizes having to buffer those the images in the web API 304.

Based on step 7 of the system 500, the classifier services 506, 508 return a plurality of classification result sets for the modified copies that were generated by the plurality of classifier services. For example only, the classification result sets can comprise a plurality of data structures 504 in an open-standard file format that uses human-readable text to transmit data objects including of attribute-value pairs and array data types (or any other serializable value). The data structures 504 can be used for asynchronous browser-server communication, including as a replacement for XML in some AJAX-style systems. For example, the data structures 504 can include a JavaScript Object Notation (JSON) object, Internet JSON (I-JSON), or others. For example, the classifier services 506, 508 return the results as a plurality of JSON objects which are collected and stored in memory of the web API 304.

Based on steps 8 and 9 of the system 500, a logic, such as a function or subroutine, such as a JavaScript Promise.all function or others, is used to wait for a response from each of the classifier services 506, 508. If each of the classifier services 506, 508 respond with a valid result, then those results will be stored. If there is an error or one of the classifier services 506, 508 fails to respond, then a resubmission process will be re-attempted for a specific set of images or a specific image or a set of classifier services 506, 508 or a specific classifier service 506, 508. After a maximum of 3 retries or others, such as 2 or 5 or more, this process will is flagged as a failed process and is logged, allowing at least one of the classifier services 506, 508 get a next image. If all classifiers return a valid result, then those results are stored in a table, such as a classifier_data table or another data structure in the PostgreSQL database 336 hosted by the database service 314, such as AWS RDS or others. For example, the classifier_data table can contain a foreign key reference to a source_images table of the PostgreSQL database 336, each classifier result can be stored as a separate row in that table, and a set of classifier data can be stored as a data structure in an open-standard file format that uses human-readable text to transmit data objects including of attribute-value pairs and array data types (or any other serializable value). The data structure can be used for asynchronous browser-server communication, including as a replacement for XML in some AJAX-style systems. For example, the data structure can include a JavaScript Object Notation (JSON) object, Internet JSON (I-JSON), or others. For example, the set of classifier data can be stored as a raw JSON in a database table, such as described above.

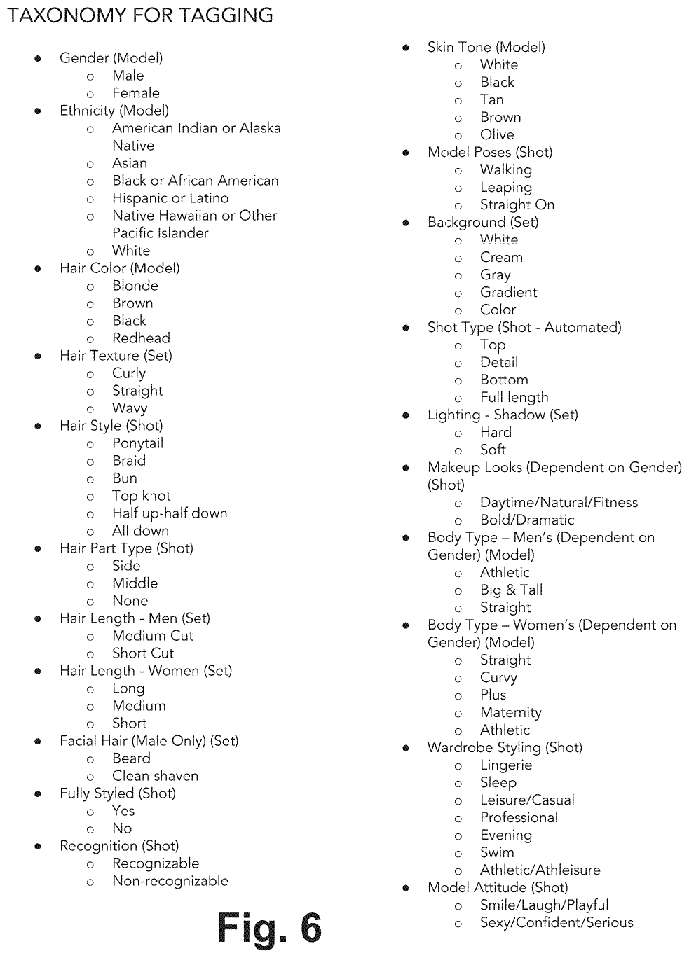

As further explained below, after image classification, canonicalization and augmentation can take place. After raw classification results are collected and stored, then such data is canonicalized based on a taxonomy for tagging. For example only, a plurality of taxonomy label sets can be utilized, where each particular taxonomy label set corresponds to a particular classification engine. The taxonomy label set can include of a variety of categories and attributes to a specific knowledge or technical domain, such as fashion photography, food photography, garment photography, equipment photography, product photography, or others. FIG. 6 shows a diagram of an embodiment of a taxonomy according to this disclosure. The classification result sets can be canonicalizing based on the taxonomy label sets to generate a plurality of canonicalized data sets. In particular, canonicalization can include a process that maps various results from various different classifiers to a normalized format to simplify downstream processing. Further, the plurality of canonicalized data sets can be merged or otherwise combined into a single data structure, which can be augmented as further described herein. An example shown below describes a canonicalization process of gender for three distinct classifiers, as explained above.
Attribute
Gender
Example Raw Classifier Outputs
Classifier 1: {general: {sex: {value: “male”}}
Classifier 2: {human_detection: {gender: {man: 80%, woman: 20%}}}
Classifier 3: {persons_gender: {masculine: 90%, feminin: 10%}}
Canonical Mapping Configuration
Classifier1: {Gender: root.general.sex.value},
Classifier2: {Gender: root.human_detection.gender},
Classifier3: {Gender: root.persons_gender}

Each classifier output for gender is unique. A canonical mapping configuration describes how each classifier outputs a gender value (if present). During the canonicalization process, these mappings are used to extract a set of appropriate gender values for each classifier and store the set of appropriate gender values under a common attribute name “Gender” to be stored in a canonicalized_data column of each classifier_data record.

Using various network-based classifier services described above, for example, classifiers can be identified using a set of classifier identification codes: AMAZON_REKOGNITION: ‘AR’, BETAFACE: ‘BF’, CLARIFAI: ‘CF’, CUSTOM_CLASSIFIER: ‘CC’, (TensorFlow), DEEPOMATIC: ‘DM’, FACE_PLUS_PLUS: ‘FP’, GOOGLE_VISION: ‘GV’, IBM_VISUAL_RECOGNITION: ‘IV’, IMAGGA: ‘IM’, MICROSOFT_FACE: ‘MF’, MICROSOFT_VISION: ‘MV’, SCALE: ‘SC’, SIGHTHOUND: ‘SH’.

After the canonicalization process has completed, e.g., by generating a single data structure corresponding to the plurality of canonicalized data sets, the canonical data can be augmented to insert additional metadata derived from various classifier outputs and thereby obtain an augmented data structure for the image. Currently, there are three augmentation functions that are performed on the set of canonical data although less or more augmentation functions can be performed as well. Some of such augmentation functions include fashion model profile augmentation, facial attribute ratio calculations, negative space calculation, or others.

Fashion model profile augmentation can be performed using facial recognition technology, where various fashion models can be automatically recognized. Then a set of detailed model profiles can be correspondingly retrieved and stored as a set of image metadata. For example, information about a fashion model, such as date of birth, ethnicity, body type, hair color, or others, can then be accurately stored as a set of image metadata. For example, some steps to adding a new model profile for fashion model profile augmentation involve a Microsoft Face API (https://docs.microsoft.com/en-us/azure/cognitive-services/face). For example, in order to perform this processing, a training set containing a minimum of 40 images of the fashion model containing a variety of different facial expressions and accessories, such as sunglasses, hats, or others, is desired. Also desired is a set of model profile information including, name, date of birth, ethnicity, or others. Once such information is gathered, various steps can be performed. Using the Microsoft Face API, a new Person is created and added to a PersonGroup. Then, using the Microsoft Face API, the Person AddFace function is used to upload a set of images from a training set under the Person ID generated in previous step. Then, a new model_profiles record is inserted to the model_profiles table in the SplashTag PostgreSQL database 336. The Person ID previously produced is stored in a model_profiles table in a person_id column to associate that model profile with the Microsoft Face API Person object. Note that some additional profile data is also inserted such as date_of_birth, ethnicity, or others. As such, when a person is detected in an image, then that Person ID will be returned in a classifier result which can then be used to query the model_profiles table and correspondingly retrieve a detailed profile information.

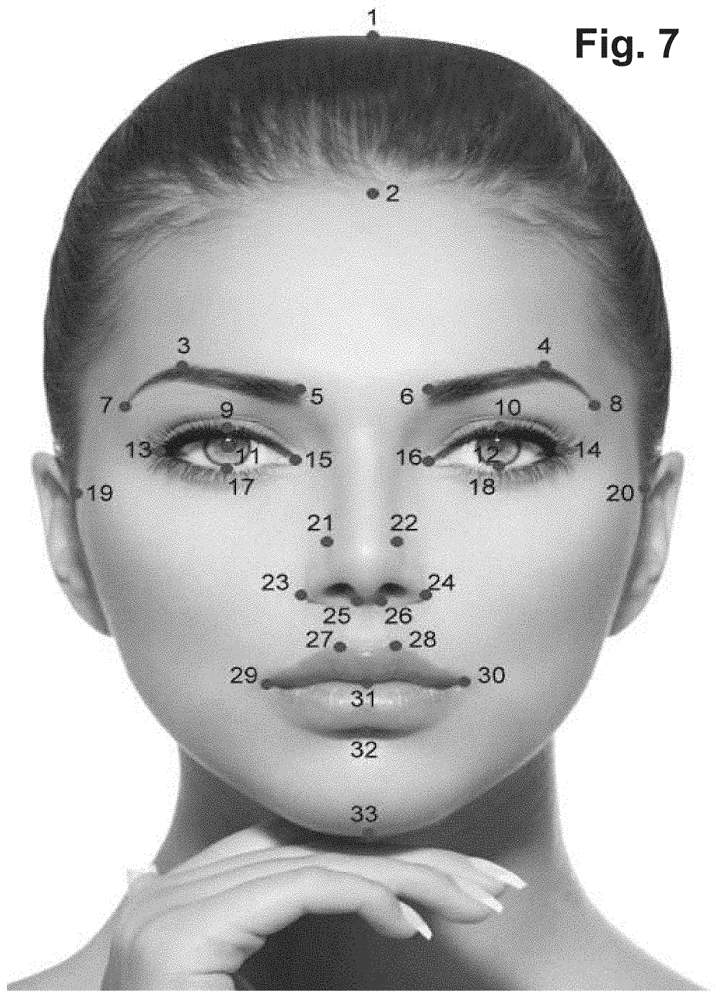

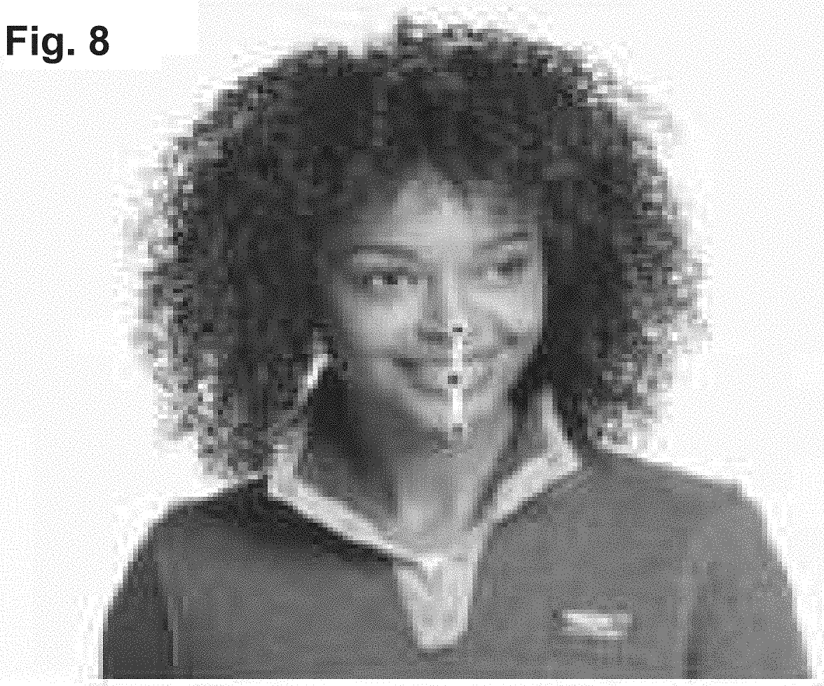

Facial attribute ratio calculations can involve a facial attribute ratio augmentor function or subroutine to calculate various ratios between different facial landmarks, such as a distance of eyes to nose, a distance nose to mouth, or others. These ratios can then be stored as metadata which can be used to identify models with similar facial features, and or identify trends in user behavior data relating to these ratios. In order to calculate the facial attribute ratios, an image is uploaded to a network-based facial classifier, such as a Face++ Landmarks Classifier (https://www.faceplusplus.com/landmarks). FIG. 7 shows a diagram of an embodiment of a face with a set of markers according to this disclosure. The set of markers includes 33 markers. Of these 33 markers, 28 are 14 sets of symmetrical markers that appear on both sides of the face. 5 other markers are on a vertical center line of the face and define proportions based on horizontal measures. As such, the network-based facial classifier can return an array of facial landmarks as x,y pixel coordinates: “faces”: [{“landmark”: {“mouth_upper_lip_left_contour2”: {“y”: 165, “_{x”:} 276}, “mouth_upper_lip_top”: {“y”: 164, “x”: 287}, “mouth_upper_lip_left_contour1”: {“y”: 164, “x”: 283}, “left_eye_upper_left_quarter”: {“y”: 131, “x”: 260}, “left_eyebrow_lower_middle”: {“y”: 126, “x”: 260} . . . ]. FIG. 8 shows a diagram of an embodiment of a face with a set of distances from nose to lips and from lips to chin according to this disclosure. These facial landmarks are then converted to a ratio using a set of calculations further explained below.

Example: Ratio of distance from Nose to Lips and from Lips to Chin
Let (x1, y1)=tip of nose
Let (x2, y2)=center of lip
Let (x3, y3)=bottom of chin
let a=distance in pixels between tip of nose to center of lip

a=\sqrt{(x₂−x₁)²+(y₂−y₁)²}
let b=distance in pixels between center of lip to bottom of chin

b=\sqrt{(x₃−x₂)²+(y₃−y₂)²}
let c=ratio of nose to lips & lips to chin

c=a/b

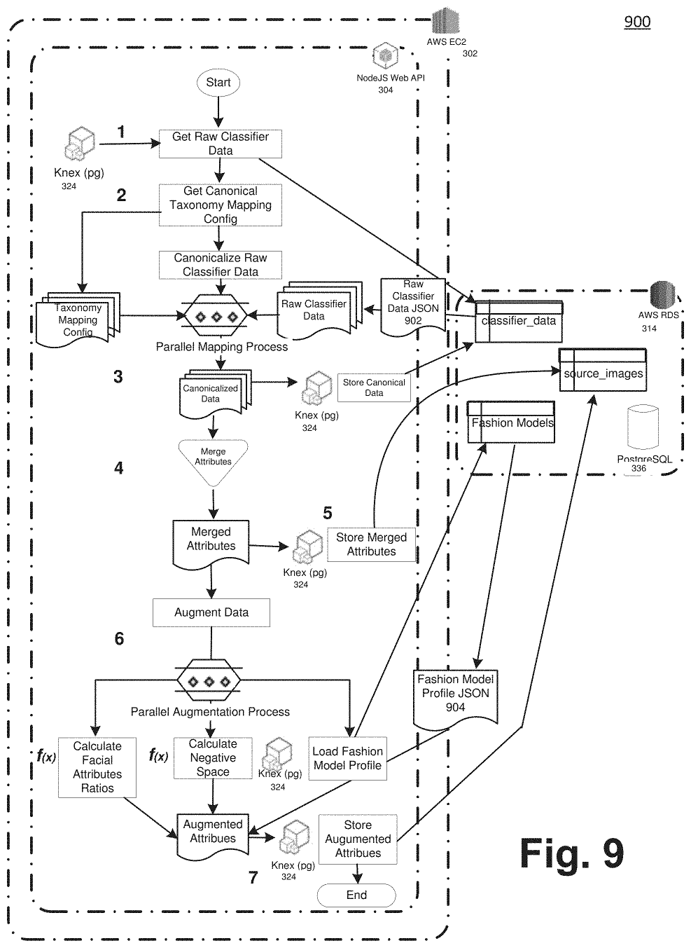

FIG. 9 shows a diagram of an embodiment of a system for canonicalization and augmentation according to this disclosure. In particular, a system 900 shares some components with the system 300 or the system 500 (similar numbering). The system 900 performs blocks 208-212 of FIG. 2 and continues from block 206. Note that although the system 900 is described in context of AWS, the system 900 is not limited to AWS and can be implemented in other ways, whether alternatively or additionally. For example, the system 900 can be implemented via Microsoft Azure, Google Cloud, IBM cloud, or others. When used in context of fashion photography, based on step 1 of the system 900, using a primary key for a source_image record in the database service 314, a set of raw classifier_data records for that image are queried, retrieved, and stored as a data structure 902 in an open-standard file format that uses human-readable text to transmit data objects including of attribute-value pairs and array data types (or any other serializable value). The data structure 902 can be used for asynchronous browser-server communication, including as a replacement for XML in some AJAX-style systems. For example, the data structure 902 can include a JavaScript Object Notation (JSON) object, Internet JSON (I-JSON), or others. For example, the data structure 902 can include a JSON array in memory of the web API 304.

Based on step 2 of the system 900, a taxonomy mapping configuration for each classifier is retrieved and used to canonicalize the set of raw classifier data records in parallel, as explained above. Based on step 3 of the system 900, a set of canonicalized records is stored in the PostgreSQL database 336 by running an UPDATE command against a classifier_data table for a canonical_output JSON column of each record that has been canonicalized.

Based on step 4 of the system 900, a set of canonical data is merged into a single object to simplify an augmentation process by allowing for selection of an attribute value by a specific classifier identification code, as explained above. Some merged attributes can be keyed by an attribute name according to the taxonomy for tagging, as explained above. Under each attribute key, a classifier value can be selected using a classifier identification code. For example, Gender.AR would select a gender classification result from Amazon Rekognition, as explained above. Likewise, Gender.CF would select a gender classification result from Clarify.

Based on step 5 of the system 900, some, most, or all merged results are stored in the PostgreSQL database 336 in a source_images table in a merged_attributes JSON column. Based on step 6 of the system 900, once merged, some, most, or all results are augmented, as explained above. Based on step 7 of the system 900, some, most, or all results, as augmented, can be stored in the PostgreSQL database 336 in the source_images table by running an UPDATE for the merged_attributes JSON column of an image being updated.

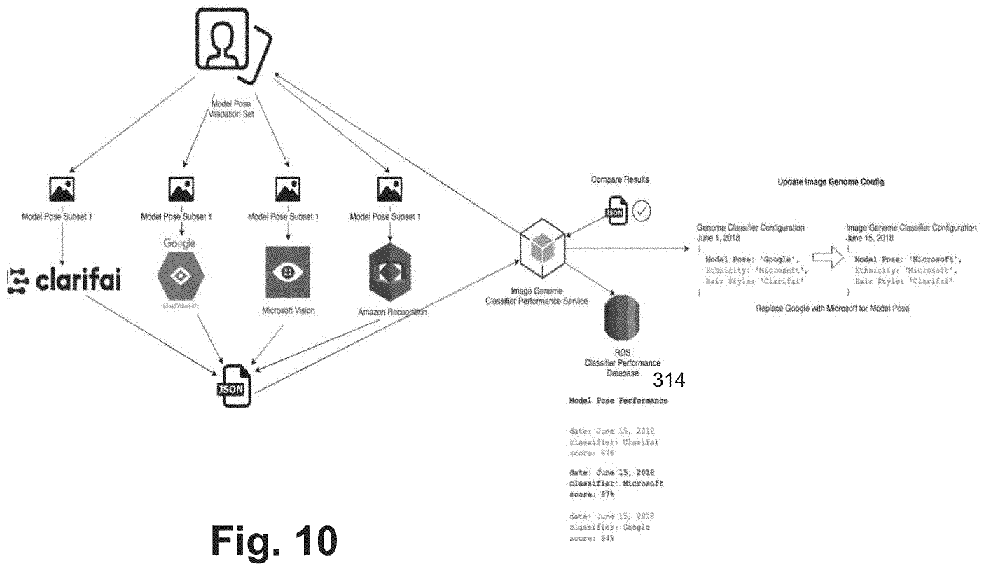

FIG. 10 shows a diagram of an embodiment of a system for selecting a classifier according to this disclosure. In particular, the computing platform 104 can automatically select a network-based classifier. Some attribute classifiers may be constantly changing in various ways, such as configurations, APIs, accuracy, precision, speed, or others. As the classifiers are retrained or modified, those classifiers may get better or worse at identifying an attribute of the image. In order to ensure that some images are tagged as accurately as possible, the classifiers may be automatically tested and some optimally performing classifiers may be automatically selected for tagging process, as explained herein.

With respect to validation sets, for each attribute being classified a validation set may be needed to test each classifier's performance. Some requirements may be valuable for a good validation set, such as a number of images, a variation of images, an exclusivity from training sets, or others. For example, with respect to the number of images, a minimum of 10,000 or more images for each attribute category may be used. For example, for a Model Pose Classifier, this group of images may include a) Straight-On 3,333 images, b) Walking 3,333 images, c) Leaping 3,334 images. For example, with respect to the variation of images, there should be a reasonable amount of variation in the images such as in studio shots, street shots, or others. This variation should capture some, most, or all possible variations of images that will be tagged by the classifiers. For example, with respect to the exclusivity from training sets, some, most, or all images used for testing classifier performance should be exclusive of some, most, or all images used for training the classifiers. If same images that are used for training are used for testing, then some of the classifiers may remember those images and may skew some, most, or all classification results.

The classifiers may be automatically tested in various ways. For example, during scheduled maintenance periods or during periods of inactivity, images from various validation sets may be sent to respective machine learning classifiers for classification. Since loading the minimum of 10,000 images (or less or more) at once could be time consuming and negatively impact overall system performance, some, most, or all images may be sent off in small subsets and classification results may be logged in a database, such as the database service 314 or others, containing a timestamp, image info, classification result, or others. These results may be accumulated over time and aggregated once some, most, or all 10,000 images (or less or more) have been classified. At that point, a classifier score will be generated and assessed. Since a correct tag is known for each image, the computing platform 104 can score each classifier based on a number of images correctly classified. Each alternative classifier may be undergo similar process, and once some, most, or all scores have been collected for each classifier, a highest performing classifier may be automatically selected and a system configuration of the computing platform 104 may be correspondingly updated, in real-time or on a deferred basis.

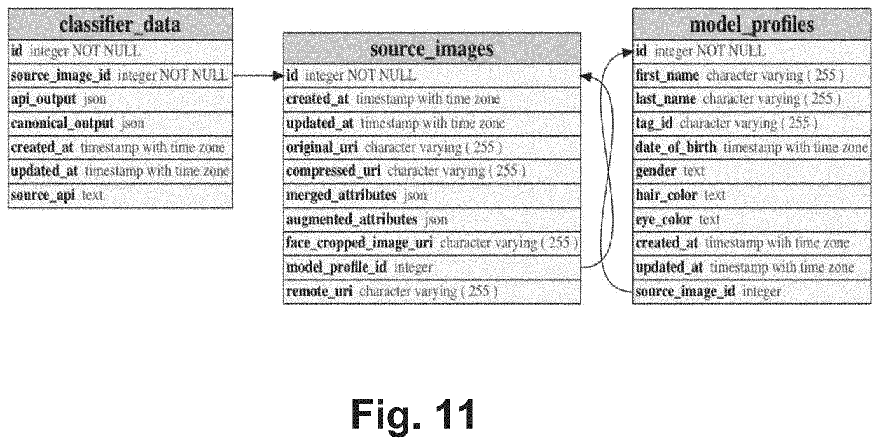

FIG. 11 shows a diagram of an embodiment of a database schema for image metadata according to this disclosure. In particular, once the computing platform 104 completes image classification, canonicalization, and augmentation, then the computing platform 104 can store image metadata a database schema of FIG. 11. Upon such storage, the computing platform 194 can granularly track user behavior based on the image metadata. For example, the user behavior can be tracked on an e-commerce website and stores those computing events in a data warehouse. This form of tracking includes various components, such as a logic for running on a user computing device, a server for capturing computing events from the user computing device, and a data warehouse for storing and enabling analysis on the computing events from the server.

The logic for running on the user computing device includes a script, a web beacon, an applet, or others. For example, the logic can include a piece of JavaScript which executes on a user's web browser and tracks various user action while on a web page, such as an e-commerce site or others. The logic is configured by the web page administrator operating the client 108 and can be included in a hypertext markup language (HTML) and JavaScript code that is downloaded by a browser of the user operating the client 110, such as a web page visitor, a search engine index crawler, or others. The logic can be executed on the browser of the user and tracks a computing behavior of the user on the web page, particularly as the computing behavior relates to engagement with images, as processed based on above. The browser of the user sends the computing events via HTTPS or another communication protocol to the server that captures the computing events. For example, the browser can send the computing events as a data structure in an open-standard file format that uses human-readable text to transmit data objects including of attribute-value pairs and array data types (or any other serializable value). The data structure can be used for asynchronous browser-server communication, including as a replacement for XML in some AJAX-style systems. For example, the data structure can include a JavaScript Object Notation (JSON) object, Internet JSON (I-JSON), or others. For example, the data structure can include JSON-formatted data containing the computing events.

The server is the web API 304 server, such as a NodeJS web server or others, responsible for receiving, geo-locating, and validating the computing events. The server is further responsible for pushing the computing events to a service for delivering real-time streaming data to a data store in order to enable real-time analytics of the computing events. The service for delivering real-time streaming data to the data store can be configured to batch, compress, and encrypt data to increase security and minimize amount of storage space needed. During transport, this service can synchronize data across various facilities in an AZ region to increase redundancy. For example, the service is invoked via creating a delivery stream through a console or an API and that delivery stream shuttles data from a data source to a specified destination, such as a storage service. Note that data can be added to the delivery stream via an API call. Note that a frequency of data delivered to a storage service is based on configurations when creating the delivery stream and aligning with a buffer size of the storage service and buffer interval. For example, the service for delivering real-time streaming data to the data store can include an AWS Kinesis Firehose.

The data warehouse can be of any type. For example, the data warehouse can include an AWS Redshift database which stores user-generated event data, with the user-generated event data being written by an AWS Kinesis Firehose.

The logic can be initialized by executing a JavaScript function on the browser of the end user operating the client 110. This function can retrieve a script code from a content delivery network (CDN) and attaches a tag function to a global window object of a web page. Invocations of the tag function proxy calls to an agent object, which is responsible for queuing and dispatching the computing events as appropriate. A purpose of the proxy function is to provide a generic interface to event script functionality as well as to ensure that the computing events tracked before the script code has been fully initialized are not discarded. The logic can enable a source identification (Source ID), a user identification (User ID), a session identification (Session ID), and an event identification (Event ID).

The Source ID uniquely identifies a web page in a context of the computing platform 104. The Source ID can include a RFC4122 (version 4) Universally Unique Identifier (UUID). The UUIDs can be generated with a Node “uuid” library (https://github.com/kelektiv/node-uuid). The Source ID is included when the script code is initialized, enabling a source of some, most, or all data transmitted to the server to be correctly identified.

The logic saves a cookie on the browser of the client 110. The cookie encodes a User ID, another v4 UUID. Upon loading, the script code checks for an existence of a previously assigned user ID, creating a new one if one is not found. The User ID accompanies some, most, or all data transmitted to the server, allowing behavior data to be linked to returning users. If a user views the web page on a different web browser or device, a new User ID can be generated.

The logic can create a Session ID (another v4 UUID) that can be stored in a storage of a session of the browser of the client 110. The Session ID can be discarded each time the browser or a tab of the browser is closed. The Session ID can enable the computing platform 104 to distinguish between user visits to the web page in order to identify new visitors from returning visitors.

Since a visitor of the web page may identify himself/herself by logging-in or may be identifiable by a cookie that has previously been stored on the browser by the web page e-commerce site itself, the logic is configured for transmission of Event ID or “identify” events, which enable the User ID to be associated with the web page identifier. This allows for future correlation of user behavior with user characteristics, such as demographic data or others.

The logic can be configured to provide a web developer with an ability to auto-track specific user behaviors for any web page of any website, for such as for a set of web pages of a website. In order to begin auto-tracking a given computing event, the web developer specifies various informational items, such as a tracking event, a stylesheet selector, an attribute name, or others. For example, the tracking event can include a computing event that the web developer is interested in tracking. For example, the stylesheet selector can include a valid cascading stylesheet selector (CSS) that identifies a relevant document object model (DOM) node for a computing event, where the CSS selector is passed to a relevant function or subroutine, such as document.querySelectorAll or others. For example, the attribute name can include an HTML attribute name, where the HTML attribute name or value is passed to element.getAttribute, where an element parent is a DOM element being auto-tracked. Note that the HTML attribute name or value can include a unique identifier global to the computing platform 104 in case of an image or a Product ID in case where a computing event relates to a product itself rather than a specific image where the product is an item being marketed on the web page and associated with an image.

For example, a snippet of code recited below is served by the computing platform 104 to the client 110. When executed, the snippet of code starts an auto-track function to track an image viewed on a web page that can market a product or contains a product listing. The snippet of code can include: splashtag(‘startAutotrack’, [{selector: ‘img[data-spl-id]’, idAttribute: ‘data-spl-id’, event: ‘img_viewed_plp’}]). When executed, the snipped of code begins to track image views for all images on a webpage which take a form of: <img src=“ . . . ” data-spl-id=“ . . . ”/>

The logic can track many computing events. Some of such events are described below. Note that these computing events can be based on an operation of a processor, a memory, an input device, an output device, or others. For example, the input device can include a mouse, a keyboard, a camera, whether forward-facing and/or back-facing, an accelerometer, a touchscreen, a biometric reader, a clicker, a joystick, a videogame controller, a microphone, or others. Likewise, the output device can include a display, a speaker, a headphone, a joystick, a videogame controller, a printer, or others. In some embodiments, the input device and the output device can be embodied in one unit, such as gyroscope, an IMU, a touch-enabled or haptic display, a magnetometer, or others. As such, the computing event can include a cursor event, a keyboard event, a display event, a speaker event, a browser event, an OS event, an application event, or others. For example, the cursor event can be based on a cursor being operated via an end user of the end user client 110. The cursor can be operated via an input device, such as a motion-tracking pointing device, a position-tracking pointing device, a pressure-tracking pointing device, or others. The motion-tracking pointing device can include a mouse, a trackball, a joystick, a pointing stick, a WiiMote or Wii Remote, a finger tracking device (tracks fingers in a 3D space or close to a surface without contact with a screen—fingers are triangulated by technologies like stereo camera, time-of-flight, laser), or others. The position-tracking pointing device can include a graphics tablet, a stylus, a touch-pad, a touchscreen, or others. The pressure-tracking device can include an isometric joystick, or others. Note that the computing event can include a non-cursor or non-keyboard event, such as an eye tracking event, a dial or knob event, an accelerometer event, an IMU event, a gyroscope event, or others. The computing event can be sent as that event occurs, in a group of computing events, a stream of events, or others.

The logic can track views. In particular, the logic can track an image viewed on a web page, such as a web page that lists a product. The image is considered “viewed” if at least 50% of the image is visible within a current viewport, measured along a Y-axis of the image. As the user scrolls up or down on the web page, various image views are recorded along with a number of times the image has been viewed. For example, if the image is viewed, then scrolled out of view, and then scrolled back into view, then the image is considered to have been viewed twice. Note that images within view are determined using an Intersection Observer API of the browser, such as explained at https://developer.mozilla.org/en-US/docs/Web/API/Intersection_Observer_API) with a poly-filled fallback, such as explained at https://www.npmjs.com/package/intersection-observer. Also, the logic can track images viewed on a web page that lists a product detail. The computing platform 104 can track which images are viewed on the web page along with how many times each image is viewed. This may be useful in a case where a web page contains a set of product images that may be cycled through by the user. Note that switching of images is tracked by registering an event listener to a “load” event on a main image node.

The logic can track durations. In particular, the logic can track an image duration on a web page. The logic can track how long an image has been viewed. A duration timer can be initialized when an image view begins (determined using a similar method as described above) and is stopped when an image view ends. Durations can be measured in milliseconds, but other units of measurement can be used as well, such as nanoseconds, seconds, minutes, or others. The duration timer can be stopped in case where the logic has determined the user has gone idle or the web page is no longer visible, as further explained below. If the user views the image multiple times, then these views can be considered to be separate views with separate durations. Note that separate durations can be logged with unique duration identifiers (IDs). This form of logging can allow the computing platform to determine aggregate analytics on image view durations, such as an average duration a single image or a set of images is viewed or others. Also, the logic can track image duration on a web page that listing a product detail. In addition to image views, the computing platform 104 can track image view durations on the web page listing the product detail, in a manner similar to a technique described above.

The logic can track hovers. In particular, the logic can track image hovered. The computing platform 104 can track a duration and location as a user hovers over an image with a cursor device. This can be useful on a web page with a product detail, where the web page implements a “magnification” effect on the image that is hovered. In order to track image hovers, an image is subdivided into a grid, such as a 10×10 rectangular grid, a square grid, a triangle grid, an oval grid, a circle grid, or others, whether symmetrical or asymmetrical, whether open shaped or close shaped, defined via a plurality of cells. Computing events handlers for “mouseenter”, “mousemove” and “mouseleave” are registered on a target element. As the user moves a cursor, such as a mouse pointer or others, over the image, a cell of the grid which enclosed the mouse pointer is periodically recorded, such as every 100 milliseconds, every 60 milliseconds, every 130 milliseconds, or others. When the cursor leaves the image (not overlaid or superimposed over the image), a hover time over each cell of the grid cell is combined and logged as part of an image hover event.

The logic can track a product-level event, such as a product image viewed on a web page hosting a product detail, a product added to an electronic shopping cart or wallet, a product purchased, or others. In particular, the computing platform 104 can auto-track product views and add to electronic shopping carts, while a product purchased event can be logged through a programmatic track function that can be invoked via an object global to the computing platform 104, such as global object splashtag (‘track’, ‘product_purchased’, {productId: ‘ . . . ’}).

The logic can enable event queuing and batching. In particular, various computing events can be transmitted over the network 102 via an HTTP or HTTPS protocol to a server, such as an event capture server or others. In order to reduce both a size of data and number of individual HTTP requests, batching and queueing mechanisms can be used. For example, a TransportQueue function or subroutine or object manages queue construction along with enqueuing and flushing data (transmitting over network to the event capture server). Data is periodically flushed, such as at rate of once every five seconds or when 1000 items have been enqueued, whichever occurs first, or others. Note that different event types can be combined in different ways. For example, two views of a same image can be aggregated into a single event with a count of two. However, two hovers over a same image should not be aggregated, as each hover event already contains a cell identifier and duration over which the hover occurred. Instead, these events can be combined into a single network transmission containing an array of hover data or another data structure of hover data, such as a que, a deck, a stack, a linked list, or others. To this end, a separate queue can be created for each event type and the TransportQueue can manage a handoff of each event the TransportQueue receives to an appropriate computing event queue, according to event type.

The logic can be configured to stash computing events. In particular, a computing event queue can have an additional or alternative responsibility, which is to stash computing events. Since various above-described mechanisms can keep user activity in memory for up to five seconds or less or more before transmitting data to a server, such as an event capture server or others, there exists a possibility that a user will close, exit or navigate away from a current web page before data has been completely transmitted. Some browsers may not allow a script, such as a JavaScript code or others, to prevent the user from navigating away from the web page. For example, in some industries, there an accepted practice that the user should not be delayed from leaving the web page in order to transmit a network request or otherwise perform any computation. To this end, the logic can instead serialize and “stash” computing events in a local storage of the browser on the client 110. If and when the user returns to that web page, then the logic can read from the local storage during an initialization procedure. If any stashed computing events are present, then the logic can flush and transmit those computing events to a server, such as an event capture server or others.

The logic may employ some considerations for user idleness and page visibility. In particular, as the logic tracks a duration for which a user is viewing an image, a video, an empty space, or a text on a web page, the logic can consider whether the user has stopped interacting with the client 110 while the web page is still focused, minimized or maximized a window or tab of the browser, switched to another tab of the browser or another browser or application, muted a tab of the browser, or others. In order to accomplish this functionality, the logic can implement an event emitter which broadcasts a computing change whenever the user transitions from an “Active” state to an “Inactive” state or an “Inactive” state to an “Active” state. For example, the logic can implement UserActiveEmitter function or subroutine or object as an extension from an event emitter implementation provided at https://github.com/primus/eventemitter3. For example, the logic can keep track of two states internally, user idleness and page visibility.

The logic can consider user idleness. In particular, a user is considered to be idle if there is a time period, such as 5 seconds or less, such as 3 seconds or more, such as 8 seconds, without the browser registering any one of a set of events that indicate user activity. Note that the time period, such as a number of seconds or milliseconds or minutes, before the user is considered idle is adjustable with a configuration setting of the computing platform 104. Likewise, various computing events which the logic can consider to be an indication of user activity can include a “mousemove” action, a “keyup” action, a “touchstart” action, a “scroll” action or others.

The logic can consider page visibility. In particular, in order to determine page visibility the logic can listen for various computing events and checks various browser properties:

| Element | Event or Property |
|---|---|
| Document | Hidden or visibility change |
| Window | Focus or blur |

Combining these two internally tracked states enables the logic to emit computing events indicating whether the user has transitioned from an “Active” state to an “Inactive” state or an “Inactive” state to an “Active” state. For example, the logic can include a duration auto-trackers to listen for these computing events, enabling the duration auto-trackers to stop or start respective duration timers appropriately.

The server for capturing computing events from the user computing device can run various processes. For example, the server can run the web API 304, such as a NodeJS (https://nodejs.org) process running an Express web framework API (https://expressjs.com) and an in-memory Redis (https://redis.io) cache. The server can be deployed to the virtual server set 302 instances, such as an AWS EC2 (https://aws.amazon.com/ec2) instances and accessible behind an elastic load balancer (ELB) (https://aws.amazon.com/elasticloadbalancing), which can be horizontally scalable, that is, any number of servers may be added to increase an available bandwidth for handling event traffic. For example, the application administrator operating the client 106 can balance network traffic with an AWS load balancing tools, including Application Load Balancer (ALB), Network Load Balancer (NLB), or others. The Express web framework API can handle HTTP or HTTPS POST requests made to a /collect endpoint from the logic, such as a computing event script, containing event data. The Express web framework API is responsible for IP address anonymization, data validation, pushing events into a correct service for delivering real-time streaming data to a data store in order to enable real-time analytics of the computing events, such as AWS Kinesis Stream (https://aws.amazon.com/kinesis/data-streams).

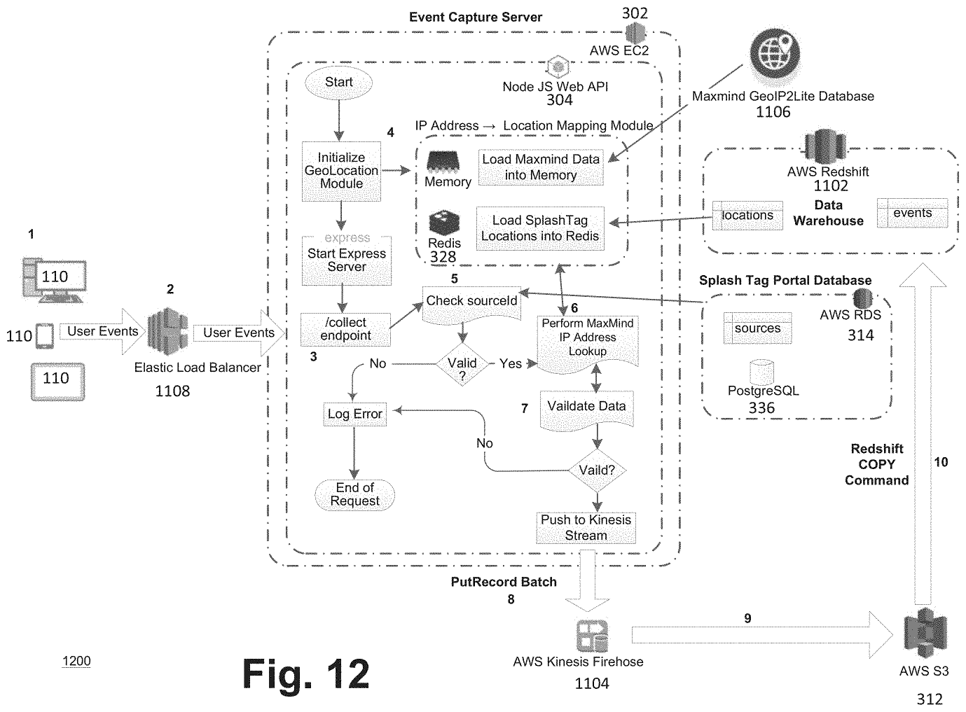

FIG. 12 shows a diagram of an embodiment of a system for capturing a computing event according to this disclosure. In particular, a system 1200 shares some components with the system 300 or the system 500 or the system 900 (similar numbering). The system 1200 performs blocks 214-220 of FIG. 2 (capturing and persisting computing events) and continues from block 212. Additionally, the computing system 1200 can perform a method for generating a recommendation for image characteristics based on the capture of computing events as discussed herein. Note that although the system 1200 is described in context of AWS, the system 1200 is not limited to AWS and can be implemented in other ways, whether alternatively or additionally. For example, the system 1200 can be implemented via Microsoft Azure, Google Cloud, IBM cloud, or others.

When used in context of fashion photography, based on step 1, the client 110, such as a desktop, a laptop, a tablet, or others, generates computing events by browsing websites, such as an e-commerce website or others. Based on step 2, the computing system 1200 can receive a computing event generated via a script of a web page open in a browser at the client 110. The computing event can be associated with an image shown on the web page and relate to engagement with the image by a user of the browser. As described more fully below, the computing event can include a web page identifier, a network address, a user identifier, and/or a session identifier. For example only, the computing events are transmitted over an HTTP protocol, an HTTPS protocol, or others. The computing platform 104 hosts or access an elastic load balancer 1108 (ELB) that can distribute some incoming client traffic to at least one of multiple event capture servers and scales resources to meet traffic demands. The ELB 1108 can be enabled within a single AZ or across multiple availability zones to maintain consistent application performance. For example, the ELB 1108 can detect of unhealthy elastic compute cloud (EC2) instances, spread instances across healthy channels, provide flexible cipher support, provide centralized management of secure sockets layer (SSL) certificates, provide optional public key authentication, support for both IPv4 and IPv6, or others. For example, the ELB 1108 can performs a health check on the virtual server set 302 to ensure an instance is still running before sending traffic to that instance. When an instance fails or is unhealthy, the ELB 1108 can route traffic to other remaining healthy computing instances. If all computing instances in a particular AZ are unhealthy, then the ELB 1108 can route traffic to other AZs until at least one of original computing instances is restored to a healthy state. For example, the ELB 1108 can be configured for auto-scaling to guarantee enough computing instances running behind the ELB 1108 (a new computing instance can spin up to meet a desired minimum based on threshold satisfaction or dissatisfaction).

Based on steps 3 and 4, an event capture server receives a computing event view at an exposed/collect endpoint. During an initialization procedure of the event capture server, a database 1106, such as a relational database, a post-relational database, an in-memory database, a hybrid database, an XML database, a parallel database, a distributed database, a graph database, a mobile database, an operation database, a probabilistic database, a real-time database, a spatial database, a temporal database, an object-oriented database, an unstructured data database, a terminology oriented database, or others, is loaded into memory of the computing platform 104. The database 1106 can contain a map mapping a set of network addresses, such as IP addresses, media access control addresses (MAC) or others, to a set of geographic data, such as a set of region names, a set of geo-fences, a set of coordinates, or others. For example, the database 1106 can include a Maxmind IP Address→Geographic data mapping. Various website and website visitor locations are fetched from a data warehouse 1102 and loaded into the in-memory database key-value store 328, such as an in-memory Redis data store. The

Based on step 5, a web page identifier, such as a Source ID explained above, included in a computing event is validated, by comparing the Source ID with a set of records in a database of a portal of the computing platform 104. Based on step 6, a loop of a network address, such as IP Address, and if successful, then a Location ID is added to a set of computing event data. Based on step 7, the set of computing event data is validated. Upon validation failure, a respective computing event is discarded. Based on step 8, upon successful validation a computing event is pushed into a service for delivering real-time streaming data to a data store 1104. For example, the service for delivering real-time streaming data to the data store 1104 can include an AWS Kinesis Firehose (chosen as determined by a Source ID of that computing event). Based on step 8, the service for delivering real-time streaming data to the data store 1104 stores a computing event in the storage service 312, such as AWS S3 bucket or others. Based on step 9, the service for delivering real-time streaming data to the data store 1104 issues a data warehouse COPY command which copies a set of data from a bucket of the storage service 312 into the data warehouse 312.

As explained above, the system 1200 performs a geolocation determination via a network address, such as an IP address or others. In particular, the event capture server attempts to map a network address of some, most, or all incoming requests to a real-world location before removing the network address from a set of event data for storage. For example, this technology can be implemented via a set of 3rd-party libraries and services. For example, A “request-ip” library (https://github.com/pbojinov/request-ip) can be used to extract a user's IP address from a HTTP request received by a server. This library can examines a series of HTTP headers which contain the user's IP address before checking a “remoteAddress” property available on “req.connection” or “req.socket” property exposed by Node. For example, to map an IP address to a real-world location, the logic running on the browser of the client 110 can use a GeoLite2 City Database provided by Maxmind (https://dev.maxmind.com/geoip/geoip2/geolite2). This database can be periodically updated monthly using a GeoIP Update program https://github.com/maxmind/geoipupdate) which is triggered by a cron job. Maxmind can support IPv4 and IPv6 network addresses and Reading from a Maxmind database can be managed by a node-maxmind library (https://github.com/runk/node-maxmind). When a node process starts, a content of the Maxmind database can be read into memory and lookups are cached using a least recently used cache. For example, if the Maxmind database contains an entry for an IP address of the client 110, then the Maxmind database returns a record containing a number of geographical data points, including country, subdivisions, such as states, provinces, or others, city, postal code, or others.

The data warehouse 1102 can stores a database of locations, where the database can store data on or in various levels, such as 3 levels, such as country, region, such as state, province, or others, administrative boundary, such as postal code, zip code, municipality, or others. These datasets can be augmented with additional information, such as population, income statistics, demographics, or others. For example, a “location” can include a tuple of (country_id, region_id, administrative_boundary_id). For example, when a node process starts, a set of locations are fetched from the database of locations and loaded into the in-memory database key-value store 328, such AWS Redis or others. Then, a record from the Maxmind database can be converted to a specific locations by way of a lookup of the in-memory database key-value store 328, such as AWS Redis. If this process is successful, then a resolved “location_id” is stored in a computing event record itself, otherwise a field of the computing event record, such as “location_id” or others, can be left blank.

The system 1200 is configured to perform data validation, as explained above. The server, such as an event capture server or others, can perform data validation. Some examples of validation can include determining a presence of required fields, such as ‘userId’, ‘sessionId’, ‘eventId’, ‘sourceId,’ a ‘createdAt’ timestamp, or others. In addition, data validation may check for numeric fields, such as ‘eventId’, ‘createdAt’, ‘count’ and ‘duration’ being valid numbers, such as whole numbers, decimal numbers, fractions, or others. If any of these validations fail, then the server can drop that respective request and log an error message.

The system 1200 is configured to push computing events onto the service for delivering real-time streaming data to the data store 1104. For example, the service for delivering real-time streaming data to the data store 1104 can include an AWS Kinesis Firehose. In order to determine a correct stream of the service for delivering real-time streaming data to the data store 1104, the web API 304 retrieves a source ID included in a set of computing event data. The web API 304 checks a local in-memory cache for metadata related to that source ID. If no metadata is found, then the web API 304 makes a network request to a portal API hosting on or accessible to the computing platform 104. The portal API which contains authoritative records of which organizations, users, and sources are registered with the computing platform 104. If no such source ID exists, then that request is dropped. Otherwise, a name of a stream of the service for delivering real-time streaming data to the data store 1104 for a given source ID is returned in response from the portal API.

The computing platform 104 maintains an object mapping stream names to node writable streams. These node writable streams are used to buffer data before pushing to a stream of the service for delivering real-time streaming data to the data store 1104. For example, a node stream can buffers 500 records for 3 seconds before pushing a set of data to the service for delivering real-time streaming data to the data store 1104 using a PutRecordBatch function that is part of an API of the service for delivering real-time streaming data to the data store 1104 https://docs.aws.amazon.com/firehose/latest/APIReference/API_PutRecordBatch.html).

The system 1200 is configured to store computing events in the data warehouse 1102, such as Redshift. For example, the computing platform 104 can employs the service for delivering real-time streaming data to the data store 1104 to load data into the data warehouse 1102, such as AWS Redshift (https://aws.amazon.com/redshift) or others. The service for delivering real-time streaming data to the data store 1104 can use the storage service 312, such as AWS S3 (https://aws.amazon.com/s3) as an intermediate data store. Note that a separate stream of the service for delivering real-time streaming data to the data store 1104 can be created for each data source. Configuring a data source can involve specifying a bucket of the storage service 312, a destination database of the data warehouse 1102, a destination database table of the data warehouse 1102 and a COPY command. The COPY command is a database of the data warehouse 1102 command which copies data from one or more files in the storage service 312 into a database table.

Once computing event data is stored in a data warehouse, as explained above, the computing platform 104 can aggregate or combine image data and computing event data using an extract, transform, and load (ETL) service. The image metadata captured by the computing platform 104, as explained above, is aggregated or combined with the user behavior data collected by the computing platform 104, as explained above, in an ETL service where tracking events can be aggregated along with image and product metadata on a periodic basis, such as second, minute, hour, daily, weekly, yearly, or others, to produce various interesting dimensions of data that can be analyzed by data scientists or through a visual analytics dashboard. For example, a single user, such as the client 110, could potentially generate thousands of events in a single session, therefore depending on a number of Daily Active Users (DAU), a number of events generated each day could reach millions. For example, a load test case can include an estimated DAU about 50,000, an estimated number of computing events per user of about 1,000, an estimated total daily events of about 50 million, and an estimated annual computing events of 18.25 billion. Based on such estimations, querying against an events table is possible but can be time consuming and have a negative impact on overall user experience of various analytics tools developed around computing event data. The ETL service runs a series of ETL jobs on a periodic schedule, such as seconds, minutes, hourly, daily, weekly, monthly, yearly, or others. The ETL jobs perform complex queries against the data warehouse to produce aggregate counts of events for a specified combination of event types, creative attributes, products, and users (audience).

In some implementations, the computing event data that is stored in the data warehouse, in combination with the augmented data structures and other image data described above, can be utilized to identify a pattern associated with one or more image characteristics that correspond to engagement with images by users. As described above, the augmented data structures can include various features or characteristics of an image, e.g., based on the classification result sets. The computing event data, which relate to the engagement with the image by users (e.g., while browsing a web page), can be analyzed, observed, parsed, etc. in conjunction with the augmented data structures to identify one or more patterns in images associated with one or more image characteristics that correspond to engagement with images by users.

For example only, and as described more fully herein, engagement with images by users can be determined in various ways, including but not limited to viewing, hovering, duration of viewing, cursor events, and product level events. Based on these patterns, a recommendation for image characteristics corresponding to one or more types of engagement with an image can be generated, e.g., by machine learning or other computing system algorithms. As mentioned above, the recommendations can inform the creative process to image objects, such as garments or others, or beings, such as people or others, based on trends and patterns captured, observed, or analyzed. In some aspects, the recommendations can be utilized, organized, summarized, or otherwise captured in a dynamic style guide that provides up-to-date guidelines for driving a desired form of user engagement with images. This type of dynamic style guide can be utilized, e.g., by a photographer, brand/marketing manager, or other creative personnel, to guide the capture of additional images based on recently acquired data (computing event data and the augmented data structures). It should be appreciated that other uses of the patterns and/or recommendations are within the scope of the present disclosure.

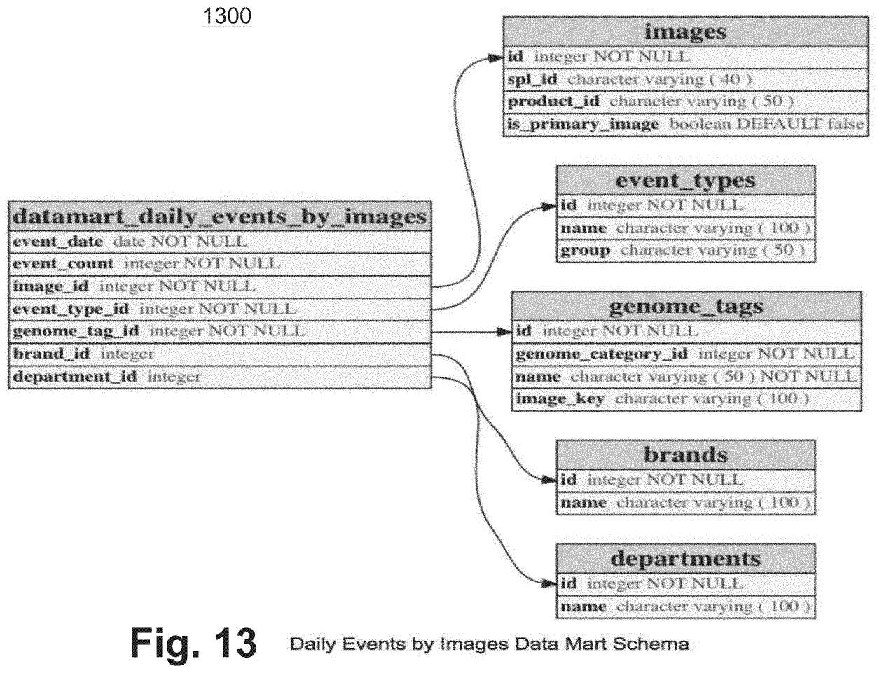

FIG. 13 shows a diagram of an embodiment of a schema of a data mart according to this disclosure. In particular, various computing event records that have been extracted from the data warehouse 1102 by the ETL service are loaded into a data mart containing a set of aggregation tables. For example, the set of data mart aggregation tables can be designed based on specific analytics use case, such as a user wanting to see various top performing images by event type and specific creative attribute given a brand, department, and timeframe. As such, a schema 1300 employs a star design although other schema designs are possible, such as a reverse star schema, a snowflake schema, or others. As such, the schema 1300 includes a center table, such as a fact table, and a line from the center table leads to a plurality of dimension tables (de-normalized). The center table has two types of columns: foreign keys to dimension tables and measures those that contain numeric facts. The center table can contain a fact's data on detail or aggregated level. Each of the dimension tables is a structure composed of a hierarchy that categorizes data. If a dimension does not have a hierarchy and levels, then the dimension table is a flat dimension or list. A primary key of each of the dimension tables can be a part of the fact table. Dimensional attributes help to describe dimensional values, which can be descriptive, textual values. At least one of the dimension table can be smaller in size than the center table. Accordingly, the center table is a datamart_daily_events_by_images table which contains event counts for events that have occurred. The dimension tables are an images table, an event_types table, a genome_tags table, a brands table, and a departments table. The dimension tables contain fewer records, and are used to describe a record of the center table. In order to optimize query speed, and storage costs, the center table stores mostly integer values, and relies on the dimension tables to store string descriptors.

The schema 1300 can be optimized for better query performance in various ways. For example, the schema 1300 can be optimized sort keys, distribution keys, or others. For example, the schema 1300 can be optimized on sort key to improve query performance against a data mart table, which enables efficient handling of range-restricted predicates, and a date column can be used as a primary sort key for some, most, or all data mart tables.

The data warehouse 1102 and a data mart based on the schema 1300 enable multi-tenancy support based on use of a multi-tenanted schema to separate a storage of each participating web page administrator data in separate tables, but keep that data contained within a single cluster of the data warehouse 1102 and a database thereof. This approach keeps operating costs down, allows for simplified maintenance, and simplifies the adding new web page administrators to the computing platform 104. For example, each participating web page administrator can be assigned a unique tenant_id: Under Armour: ua, Target: tg, Victoria's Secret: vs, or others. The unique tenant_id is then prefixed to various table names in the data warehouse 1102 and data mart schemas, such as ua_events, tg_events, vs_events, or others. When a new web page administrator signs up to use the computing platform 104, a logic, such as a script or others, is run that creates some, most, or all necessary tables using the new tenant_id prefix. This is process is referred to as database migrations.

In order to extract records from the data warehouse 1102, the computing platform 104 extracts new event records from the data warehouse 1102. A record of a last successful run date of the ETL job is kept in the etl_job_tracking table in the data mart. This date will be used in a query to only include event records that occurred after the last run date. Since this extraction can involve extracting a large number of records and potentially having to store these records in memory before a transform function and a load function could be performed, the data warehouse 1102 can be enabled to use an UNLOAD command, such as an UNLOAD command from an AWS Redshift or others, to unload an extracted row to a bucket of the storage service 312 for temporary storage. For example, the UNLOAD command from an AWS Redshift (https://docs.aws.amazon.com/redshift/latest/dg/r_UNLOAD.html) can be issued to Redshift as a query using a Knex raw command (https://knexjs.org/#Raw-Queries) from a NodeJS service, and a record can be streamed directly to a bucket of the storage service 312 without needing to pass through the NodeJS service, therefore reducing load on the storage service 312 itself.

In order to transform records that have been extracted, as described above, since an extract function of the data warehouse 1102 transfers a computing event record directly to the storage service 312, a transformation can occur at a query level. For example, a transformation can involve aggregate counts and ranking of event records by a combination of different dimensions.

In order to load records that have been transformed, as described above, into a data mart, as described above, after an UNLOAD command (https://docs.aws.amazon.com/redshift/latest/dg/r_COPY.html) completes a transfer of records from the data warehouse to the storage service 312, the web API 304 issues a COPY command to a data mart of the data warehouse 1102. A COPY command streams computing events from a temporary event store in the storage service 312 to the data mart where the computing events are stored in respective tables using the schema 1300, as described above.

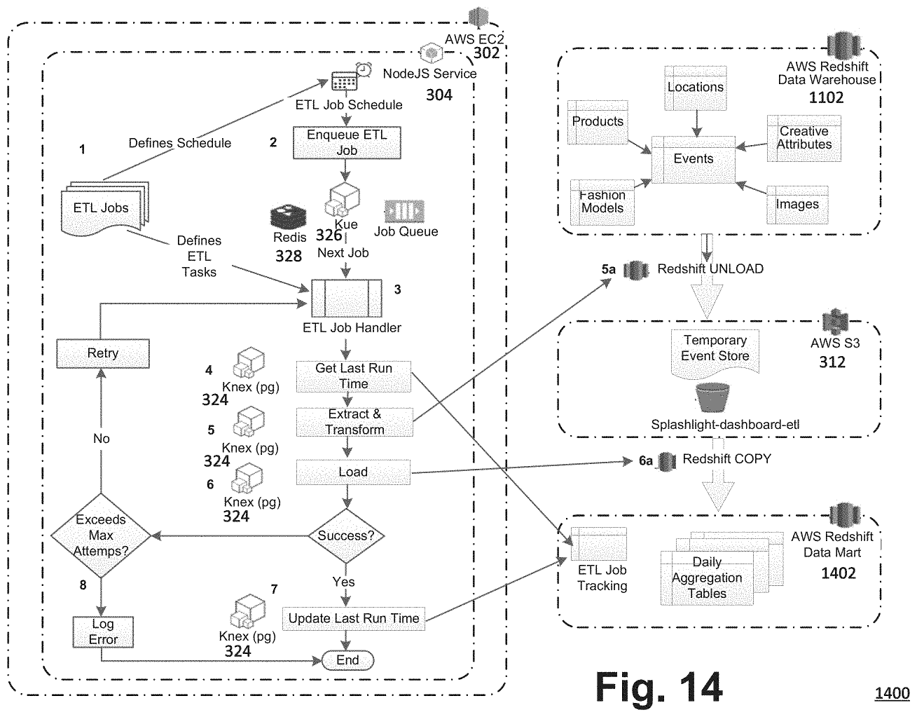

FIG. 14 shows a diagram of an embodiment of a system for performing an extract, transform, and load (ETL) job according to this disclosure. In particular, a system 1400 shares some components with the system 300 or the system 500 or the system 900 or the system 1200 (similar numbering). The system 1400 performs blocks 222-224 of FIG. 2 and continues from block 220. Note that although the system 1400 is described in context of AWS, the system 1400 is not limited to AWS and can be implemented in other ways, whether alternatively or additionally. For example, the system 1400 can be implemented via Microsoft Azure, Google Cloud, IBM cloud, or others.

When used in context of fashion photography, based on step 1 of the system 1400, an ETL job configuration file defines a scheduling for each ETL job. Based on step 2 of the system 1400, via the ETL job configuration file, an ETL job scheduler automatically queues jobs from processing. For example, the jobs can be queued in the in-memory database key-value store 328, such as a AWS Redis in-memory data store, and managed using the priority job queue 326, such as a Kue.js job processor (https://github.com/Automattic/kue) or others. Based on step 3 of the system 1400, the ETL job handler get a next job from a queue and loads a job configuration, which contains the ETL function to be executed by a process() function of the ETL job handler. Based on step 4 of the system 1400, the process() function first initializes a job and gets a last_run_at value from an etl_job_tracking table of a data mart 1402. The last_run_at value ensures that only new events are processed in the ETL job. Based on step 5 of the system 1400, the job handler then executes an extract() function of that job. The extract function contains a complex select statement that is executed with an UNLOAD command to the data warehouse 1102 to transfer a set of data to a bucket of the storage service 312. The select statement contains additional transformation logic to perform aggregate counts and rankings, as needed. Based on step 6 of the system 1400, the job handler then executes the load() function. The load() function issues a COPY command to the data mart 1402 and copies various records from a bucket of the storage service 312 into a table of the data mart 1402. Based on step 7 of the system 1400, if the job is successful the etl_job_tracking table is updated with a last_run_at value and the job is completed. Based on step 8 of the system 1400, if the job fails, the job will be retried at least one time, such as two times, three times, or more, before an error is logged and the job is terminated.

Once a table in the data mart 1402 is at least partially populated, then the computing platform 104 can be configured to enable data visualization in an analytics dashboard. In particular, once at least some data has been aggregated into the table of the data mart 1402, then that data can be analyzed in an application containing a dashboard, with such analysis taking place though a variety of creative data visualization widgets. The application can include a web application and the dashboard is designed to allow for various interesting data visualizations and filtering options to offer creative, marketing, and analytics teams valuable insights into how users are interacting with imagery on web sites that have been configured to be in communication with the computing platform 104. For example, the dashboard can include a web based client server application built using a React JavaScript Library (https://reactjs.org) and a NodeJS API (https://nodejs.org/en). The dashboard can host a web API that serves the application. The web API exposes a series of endpoints that can be used to request data from the table of the data mart 1402. Requests to the data mart 1402 can include a number of different query parameters that are used to filter the data and return a subset of various aggregated events. The web API can use a Express JS API (https://expressjs.com), which can enable a minimal and flexible Node.js web application framework that provides a robust set of features for web and mobile applications. The web API endpoints can be secured using a JSON Web Token (JWT) where all requests can contain a valid authorization token encoded with a tenant claim. This tenant claim is used to query a correct tenanted table in a multi-tenanted database. The JWTs can be generated and signed using a 3rd party identity service called Auth0 (https://auth0.com/docs/jwt).

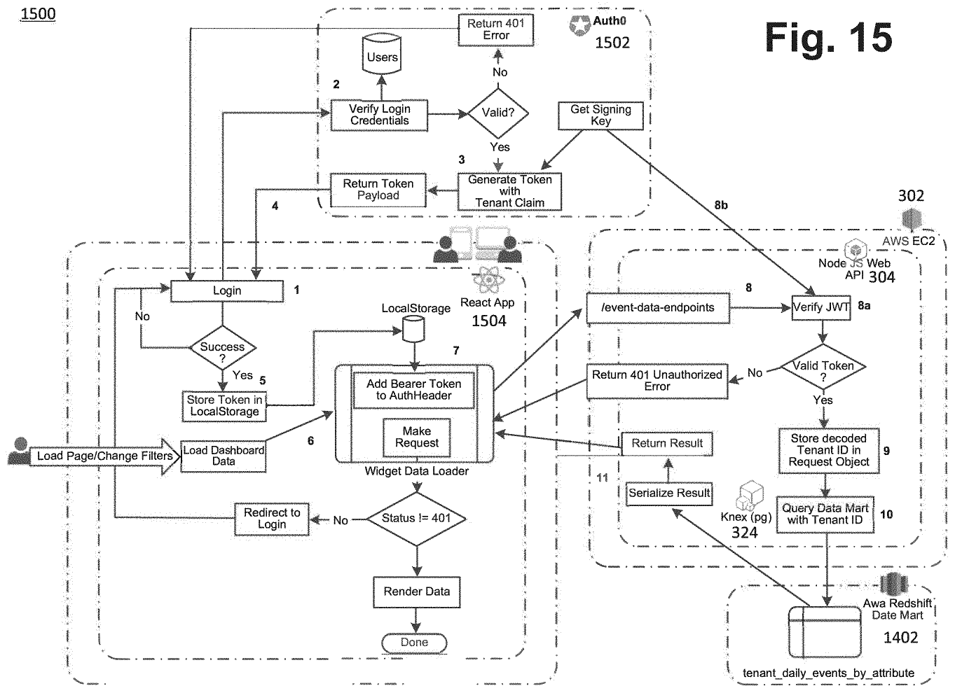

FIG. 15 shows a diagram of an embodiment of a system for authentication an API request for accessing a dashboard according to this disclosure. In particular, a system 1500 shares some components with the system 300 or the system 500 or the system 900 or the system 1200 or the system 1400 (similar numbering). The system 1500 performs blocks 226-236 of FIG. 2 and continues from block 224. Note that although the system 1500 is described in context of AWS, the system 1500 is not limited to AWS and can be implemented in other ways, whether alternatively or additionally. For example, the system 1500 can be implemented via Microsoft Azure, Google Cloud, IBM cloud, or other.

When used in context of fashion photography, based on step 1 of the system 1500, the web page operator operating the client 108 accesses a dashboard over the network 102 and enters credentials into a lock widget, such as an Auth0 widget (https://auth0.com/docs/libraries/lock/v11) or others. For example, this can be manifested via an embeddable login in a single page app. Based on step 2 of the system 1500, the lock widget posts the credentials to a network-based API 1502, such as an Auth0 API or others, where a user name and password, which can be inclusive of biometrics, is verified. For example, the network-based API can be hosted internal or external to the computing platform 104 or at least one of the client 106, the client 108, or the client 110 or another computing platform or device. Based on step 3 of the system 1500, if the user name and password is valid, then the API 1502 generates an access token encoded with a claim for a tenant_id for that user. Based on step 4 of the system 1500, assuming valid credentials, an encoded JWT is returned to the client 108. Based in step 5 of the system 1500, the JWT is stored in a local storage of a browser of the client 108. Based on step 6 of the system 1500, if a web page is loaded or a filter setting is modified, then a widget data loader requests data from the web API that serves the application. Based on step 7 of the system 1500, a widget data loader can make a request to a specific endpoint of the web API using a client API middleware (the API middleware injects the token (if available) into a request header). Based on step 8 of the system 1500, when a request is received by a node express API, the node express API first checks that the request contains a valid token in an authorization header. Note that the JWT can be verified using express-JWT (https://github.com/auth0/express-jwt). Further, note that a signing key for the JWT used to verify a validity of the JWT is loaded from the network-based API 1502 using (https://github.com/auth0/node-jwks-rsa). Based on step 9 of the system 1500, if the JWT is valid, then the JWT is decoded and a user object containing the tenan_id is stored in an express request object in local memory of the client 108. Based on step 10 of the system 1500, the tenant_id can then be used to generate a query to a correct tenanted table in the data mart 1402. Based on step 11 of the system 1500, a result from the query is then serialized, and returned to the client 108.

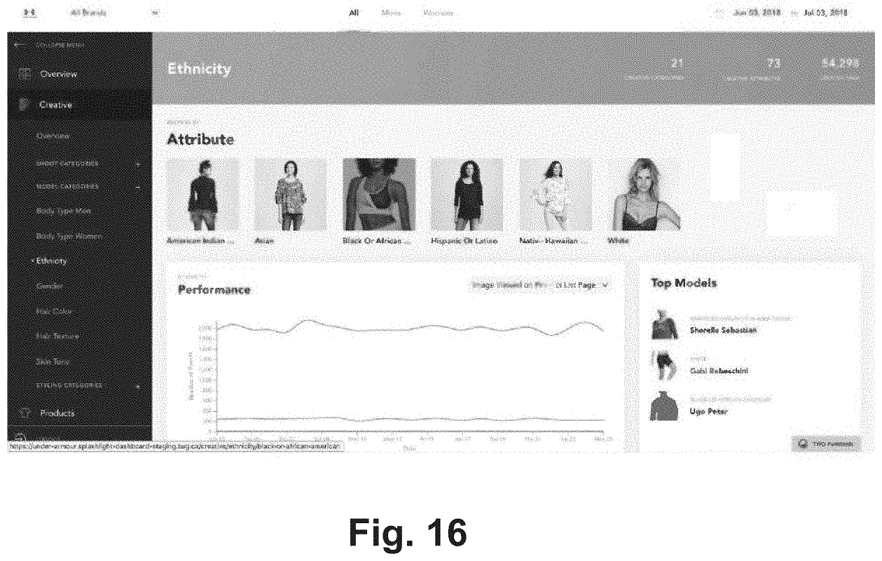

FIG. 16 shows a screenshot of an embodiment of a dashboard of a web application according to this disclosure. In particular, the computing platform 104 is configured to enable data visualizing data on the client 108 over the network 102. Based on above, an aggregated event dataset returned from the web API 304 is visualized in a dashboard style web application, such as via a ReactJS library or others. The dashboard style web application can employ a variety of data visualization widgets based on a D3.js JavaScript library (https://d3js.org), MapBox.js (https://www.mapbox.com) or others, as well as some customized developed widgets.

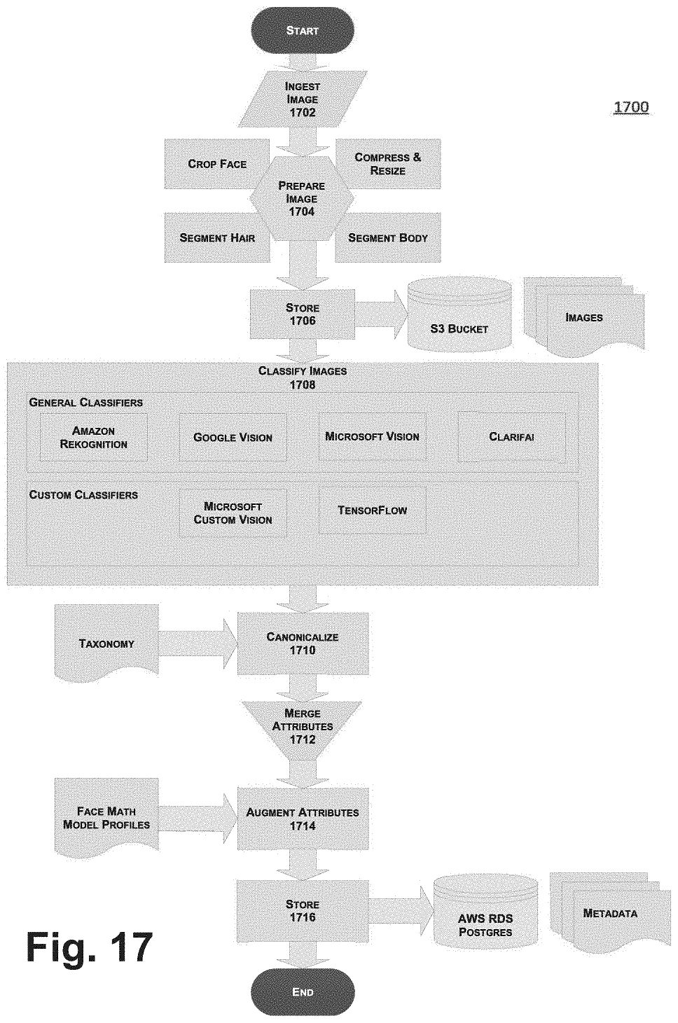

FIG. 17 shows a flowchart of an embodiment of a process for augmenting a set of canonical data obtained based on a plurality of results from a plurality of network-based classification engines according to this disclosure. In particular, a process 1700 can be performed based on FIGS. 1-16. In block 1702, the computing platform 104 ingests an image. In block 1704, the computing platform 104 can preprocess the image, such as via cropping face, segmenting hair, compress, resize (to meet classification requirements), segment body, or others. In block 1706, the computing platform 104 stores the image, as preprocessed. For example, such storage can take place via a bucket of the storage service 312. In block 1708, the computing platform 104 can submit the image for classification via a plurality of network-based classification engines or classify the image. For example, when the image is a plurality of images, then an appropriate image can be selected for each classification engine, such as face crop image is used for model detection, eye contact, smile detection, or others, or human body segmented image is used for pose detection or others, or others. In block 1710, the computing platform 104 employs a taxonomy document, such as a file or others, to canonicalize a set of classification results from the network-based classification engines. In block 1712, the computing platform 104 merges a canonicalization result into a single data structure, such as a JSON object or others. In block 1714, the computing platform 104 augments (supplements) the single data structure by additional data and mathematics, such as face math for ratios, model profiles of detected models, negative space, or others. In block 1716, the computing platform 104 stores that data via the database service 314.

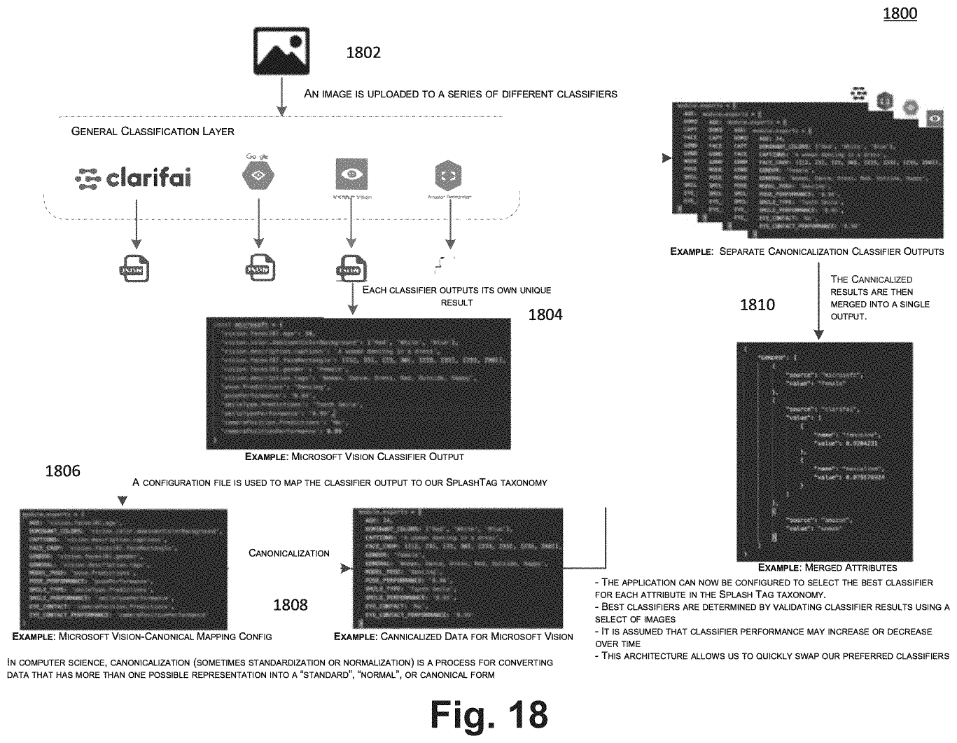

FIG. 18 shows a flowchart of an embodiment of a process for swapping a plurality of network-based classification engines according to this disclosure. In particular, a process 1800 can be performed based on FIGS. 1-17. In block 1802, the computing platform 104 uploads an image to a plurality of network-based classification engines. In block 1804, the computing platform 104 receives a plurality of results from the network-based classification engines. In block 1806, the computing platform 104 accesses a plurality of configuration files to map the results a taxonomy document. In block 1808, the computing platform 104 canonicalizes the results based on the taxonomy document. In block 1810, the computing platform 104 the results, as canonicalized, are merged into a single output, such as a data structure, such as a JSON object or others. As such, the computing platform 104 is configured to select an optimal network-based classification engine for each attribute in the taxonomy document. For example, an optimal network-based classification engine can be determined by validating classifier results using a select of images (classifier accuracy or precision or speed may increase or decrease over time). For example, the process 1800 enables allows us to quickly swap classifiers, which can be in real-time.

In addition, features described with respect to certain example embodiments may be combined in or with various other example embodiments in any permutational or combinatory manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to be-come coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or pro-gram statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as dis-closed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required be-fore, after, and/or concurrently with example embodiments, as disclosed herein. Note that any and/or all methods and/or processes, at least as disclosed herein, can be at least partially performed via at least one entity or actor in any manner.

Although preferred embodiments have been depicted and described in detail herein, skilled artisans know that various modifications, additions, substitutions and the like can be made without departing from spirit of this disclosure. As such, these are considered to be within the scope of the disclosure, as defined in the following claims.

1. A computer-implemented method for generating an augmented data structure for an image, comprising:
generating, via a computing device having one or more processors, a plurality of copies of the image;
applying, via the computing device, a plurality of preprocessing techniques to the copies to generate modified copies, the modified copies corresponding to modified versions of the copies based on the preprocessing techniques;
causing, via the computing device, each modified copy to be stored in a particular virtualized storage unit of a plurality of virtualized storage units, wherein selection of the particular virtualized storage unit for each modified image is based on the preprocessing techniques utilized to obtain that modified image;
retrieving, via the computing device, a plurality of classifier settings for a plurality of classification engines, each classifier setting of the plurality of classifier settings corresponding to a particular classification engine and specifying a type of image to be classified by the particular classification engine;
causing, via the computing device, the modified copies to be sent from the plurality of virtualized storage units to the classification engines based on the classifier settings;
receiving, via the computing device, a plurality of classification result sets for the modified copies from the classification engines, the plurality of classification result sets being generated by the plurality of classification engines;
accessing, via the computing device, a plurality of taxonomy label sets, each particular taxonomy label set corresponding to a particular classification engine and including categories or attributes to a specific knowledge or technical domain of the image;
canonicalizing, via the computing device, the classification result sets based on the taxonomy label sets to generate a plurality of canonicalized data sets;
merging, via the computing device, the plurality of canonicalized data sets into a single data structure; and
augmenting, via the computing device, the data structure with a set of metadata derived from the classification result sets to obtain the augmented data structure for the image.

2. The computer-implemented method of claim 1, wherein the plurality of preprocessing techniques includes resizing and cropping.

3. The computer-implemented method of claim 1, wherein at least one of the classifier settings comprises a document in an open-standard file format that uses human-readable text to transmit data objects including of attribute-value pairs.

4. The computer-implemented method of claim 1, wherein at least one of the taxonomy label sets is based on a plurality of features of a human.

5. The computer-implemented method of claim 1, wherein the single data structure is a single object such that augmenting the single data structure with the set of metadata is simpler via allowing for a selection of an attribute value by a specific classifier identification code.

6. The computer-implemented method of claim 1, wherein canonicalizing the classification result sets is performed in parallel.

7. The computer-implemented method of claim 1, wherein at least one of the classification result sets is stored as an array before canonicalizing.

8. The computer-implemented method of claim 1, wherein the set of metadata is based on recognizing a face in at least one of the copies, retrieving a profile associated with the face, copying an element from the profile, and inserting the element into the set of metadata.

9. The computer-implemented method of claim 1, wherein the set of metadata is based on determining a ratio between a plurality of features in at least one of the copies and inserting the ratio into the set of metadata.

10. The computer-implemented method of claim 1, wherein the set of metadata is based on determining a negative space in at least one of the copies, generating a value based on the negative space, and inserting the value into the set of metadata.

11. A computing system for generating an augmented data structure for an image, comprising:
one or more processors; and
a non-transitory computer-readable storage medium having a plurality of instructions stored thereon, which, when executed by the one or more processors, cause the one or more processors to perform operations comprising:
generating a plurality of copies of the image;
applying a plurality of preprocessing techniques to the copies to generate modified copies, the modified copies corresponding to modified versions of the copies based on the preprocessing techniques;
causing each modified copy to be stored in a particular virtualized storage unit of a plurality of virtualized storage units, wherein selection of the particular virtualized storage unit for each modified image is based on the preprocessing techniques utilized to obtain that modified image;
retrieving a plurality of classifier settings for a plurality of classification engines, each classifier setting of the plurality of classifier settings corresponding to a particular classification engine and specifying a type of image to be classified by the particular classification engine;
causing the modified copies to be sent from the plurality of virtualized storage units to the classification engines based on the classifier settings;
receiving a plurality of classification result sets for the modified copies from the classification engines, the plurality of classification result sets being generated by the plurality of classification engines;
accessing a plurality of taxonomy label sets, each particular taxonomy label set corresponding to a particular classification engine and including categories or attributes to a specific knowledge or technical domain of the image;
canonicalizing the classification result sets based on the taxonomy label sets to generate a plurality of canonicalized data sets;
merging the plurality of canonicalized data sets into a single data structure; and
augmenting the data structure with a set of metadata derived from the classification result sets to obtain the augmented data structure for the image.

12. The computing system of claim 11, wherein the plurality of preprocessing techniques includes resizing and cropping.

13. The computing system of claim 11, wherein at least one of the classifier settings comprises a document in an open-standard file format that uses human-readable text to transmit data objects including of attribute-value pairs.

14. The computing system of claim 11, wherein at least one of the taxonomy label sets is based on a plurality of features of a human.

15. The computing system of claim 11, wherein the single data structure is a single object such that augmenting the single data structure with the set of metadata is simpler via allowing for a selection of an attribute value by a specific classifier identification code.

16. The computing system of claim 11, wherein canonicalizing the classification result sets is performed in parallel.

17. The computing system of claim 11, wherein at least one of the classification result sets is stored as an array before canonicalizing.

18. The computing system of claim 11, wherein the set of metadata is based on recognizing a face in at least one of the copies, retrieving a profile associated with the face, copying an element from the profile, and inserting the element into the set of metadata.

19. The computing system of claim 11, wherein the set of metadata is based on determining a ratio between a plurality of features in at least one of the copies and inserting the ratio into the set of metadata.

20. The computing system of claim 11, wherein the set of metadata is based on determining a negative space in at least one of the copies, generating a value based on the negative space, and inserting the value into the set of metadata.

21.-80. (canceled)
